(19) United States
(12) Patent Application Publication
(10) Pub. No.: US 2026/0050887 A1
(43) Pub. Date: Feb. 19, 2026

(54) AUTOMATED PHOTO/VIDEO DOCUMENTATION SYSTEM FOR SUPPLY CHAIN OPERATIONS

(71) Applicant: Smart Gladiator LLC, Duluth, GA (US)

(72) Inventor: Pugazhenthi Sankaralingam, Duluth, GA (US)

(21) Appl. No.: 19/291,246

(22) Filed: Aug. 5, 2025

Related U.S. Application Data
(60) Provisional application No. 63/680,308, filed on Aug. 7, 2024.

(51) Int. Cl. G06Q 10/087; G06F 3/04883; G06K 19/06

(52) U.S. Cl. CPC G06Q 10/0877; G06F 3/04883; G06K 19/06028

(57) ABSTRACT

A system for automated photo and/or video capture of pallets in a supply chain environment includes a photo/video capture tunnel with a frame structure. The system may include cameras mounted on the frame structure. At least one mobile device may be configured to capture metadata associated with pallets positioned within the photo/video capture tunnel. The mobile device may also transmit a signal to initiate photo and/or video capture. A cloud-based storage system may be configured to receive and store photos and/or videos and associated metadata from the cameras. Each of the cameras may be configured to receive the signal to initiate photo and/or video capture. The cameras may capture at least one photo and/or video of the pallets positioned within the photo/video capture tunnel. The cameras may transmit the at least one photo and/or video and the associated metadata to the cloud-based storage system.

### RELATED APPLICATION

Under provisions of 35 U.S.C. § 119 (e), the Applicant claims benefit of U.S. Provisional Application No. 63/680,308 filed on Aug. 7, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to logistics and supply chain management. More specifically, the disclosure pertains to systems and devices for automating and streamlining the process of capturing high-quality photographic and/or videographic documentation of pallets and their labels in a warehouse setting.

### BACKGROUND

Supply chain operations may involve the documentation of goods during various stages of handling and transportation. Photographic and/or videographic evidence may be used to verify the condition and contents of shipments. This documentation process may be crucial for resolving disputes and maintaining transparency across the supply chain.

Conventional methods of capturing photographic evidence in warehouses may rely on manual processes. These manual processes may be time-consuming and prone to human error. The quality and consistency of documentation may vary depending on individual worker knowledge and performance.

Warehouse staff may need to be trained on proper documentation procedures. This training may be resource-intensive and may not guarantee uniform results across all employees. The reliance on manual processes may also lead to increased labor costs and potential inefficiencies in warehouse operations.

In the event of disputes regarding shipment contents or condition, the lack of clear and consistent photographic evidence may pose challenges. Resolution of these disputes may be difficult without reliable documentation, potentially resulting in financial losses or strained business relationships.

The integration of automated systems in warehouse operations may be increasing. However, solutions specifically addressing photographic and/or videographic documentation may be limited. There may be a need for tailored solutions that can seamlessly integrate with existing digital management systems, such as Enterprise Resource Planning (ERP) and Warehouse Management Systems (WMS).

Traditional warehouse documentation processes may also face challenges related to data accessibility and retrieval. When photographic evidence is captured manually, the organization and storage of these images may be inconsistent. This inconsistency may make it difficult to quickly locate specific documentation when needed for verification or dispute resolution purposes.

In time-sensitive supply chain operations, delays in documentation processes may impact overall operational efficiency. Manual photography of pallets may create bottlenecks, particularly during peak shipping periods. These bottlenecks may result in delayed shipments and reduced throughput capacity for warehouse facilities.

The quality of manually captured images may also be inconsistent due to varying lighting conditions in warehouse environments. Poor lighting may result in unclear photographs that fail to adequately document the condition of goods. This inadequate documentation may complicate claims processing and dispute resolution when shipment damages occur.

Compliance with industry standards and regulations may present additional challenges. Different customers or regulatory bodies may have specific documentation requirements. Meeting these varied requirements through manual processes may be complex and may increase the risk of non-compliance.

Data security concerns may also arise with conventional documentation methods. The transmission and storage of sensitive shipment information may not always follow secure protocols. This lack of security may potentially expose confidential supply chain data to unauthorized access.

The scalability of manual documentation processes may be limited. As warehouse operations grow, the documentation workload may increase proportionally. Without automated solutions, scaling documentation capabilities may require significant additional staffing resources.

Cross-facility standardization may be difficult to achieve with manual documentation approaches. Different warehouse locations within the same organization may develop varying documentation practices. This variation may complicate company-wide data analysis and reporting efforts.

In multi-party supply chain operations, the transfer of documentation between entities may be inefficient. Manual processes may not facilitate seamless sharing of visual evidence across different stakeholders in the supply chain. This inefficiency may impede collaboration and transparency between supply chain partners.

The environmental impact of traditional documentation methods may also be considerable. Paper-based documentation systems may consume significant resources and generate waste. Digital solutions that reduce paper consumption may align better with sustainability initiatives in modern supply chain operations.

Efficient and accurate documentation processes may contribute to improved operational efficiency in warehouses. Reduction of errors in documentation may lead to smoother logistics operations and enhanced customer satisfaction. Streamlined documentation processes may also facilitate faster dispute resolution and improve overall supply chain visibility.

The growing complexity and scale of modern supply chain operations have intensified the need for accurate, efficient, and standardized documentation systems. As global trade networks expand and consumer expectations for rapid delivery increase, the traditional manual methods of documenting pallet conditions and contents have become increasingly inadequate. These manual processes create significant operational bottlenecks, particularly during peak shipping periods, and represent a substantial allocation of human resources that could be better utilized for value-added activities. Furthermore, the inconsistency in documentation quality due to varying lighting conditions, photographer skill levels, and documentation protocols across different warehouse facilities makes it difficult to establish reliable visual records for quality control and dispute resolution purposes. This inconsistency is particularly problematic in multi-party supply chain operations where seamless information sharing between stakeholders is essential for maintaining transparency and accountability throughout the logistics process.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure may relate to systems and methods for automated photo/video capture and documentation of pallets in a supply chain environment. Various embodiments may be described herein.

A system for automated photo and/or video capture of pallets in a supply chain environment may comprise a content capture tunnel comprising a frame structure. The system may include a plurality of cameras mounted on the frame structure. The system may include at least one mobile device configured to capture metadata associated with one or more pallets positioned within the content capture tunnel. The at least one mobile device may be configured to transmit a signal to initiate content capture. The system may include a cloud-based storage system configured to receive and store content and associated metadata from the plurality of cameras. Each of the plurality of cameras may be configured to receive the signal to initiate content capture. Each of the plurality of cameras may be configured to capture content comprising at least one photo or video of the one or more pallets positioned within the content capture tunnel. Each of the plurality of cameras may be configured to transmit the captured content and the associated metadata to the cloud-based storage system.

A system for automated documentation of pallets in a supply chain environment may comprise a documentation station comprising a frame structure. The system may include a plurality of imaging devices mounted on the frame structure. The system may include a control device configured to obtain load identification data associated with pallets positioned within the documentation station. The control device may be configured to transmit a capture signal to the plurality of imaging devices. The system may include a data storage system. Each of the plurality of imaging devices may be configured to receive the capture signal from the control device. Each of the plurality of imaging devices may be configured to, in response to receiving the capture signal, capture at least one image of the pallets positioned within the documentation station. Each of the plurality of imaging devices may be configured to transmit the at least one image and the load identification data to the data storage system.

A method for capturing and managing pallet documentation in a supply chain environment may comprise receiving load identification data for a pallet. The method may include transmitting a signal to initiate photo and/or video capture and the load identification data to a plurality of camera devices. The method may include capturing, by each of the plurality of camera devices, at least one image of the pallet from different angles. The method may include generating metadata associated with the captured images, wherein the metadata may comprise the load identification data. The method may include uploading the captured images and associated metadata to a storage system. The method may include determining if a load record corresponding to the load identification data may exist in the storage system. The method may include, responsive to a determination that the load record corresponding to the load identification data may exist, adding the uploaded images and metadata to the existing load record. The method may include, responsive to a determination that the load record corresponding to the load identification data may not exist, creating a new load record corresponding to the load identification data, the new load record comprising the uploaded images and metadata.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment of an automated photo and/or video documentation system for supply chain operations consistent with the present disclosure;

FIG. 2A illustrates a side view of a photo/video capture tunnel for use with the automated photo and/or video documentation system for supply chain operations;

FIG. 2B illustrates a front view of a photo/video capture tunnel for use with the automated photo and/or video documentation system for supply chain operations;

FIG. 2C illustrates a top view of a photo/video capture tunnel for use with the automated photo and/or video documentation system for supply chain operations;

FIG. 2D schematically illustrates a perspective view of an alternate embodiment of a photo/video capture tunnel for use with the automated photo and/or video documentation system for supply chain operations, in a warehouse setting;

FIG. 2E illustrates an embodiment of a frame for a photo/video capture tunnel for use with the automated photo and/or video documentation system for supply chain operations, in a warehouse setting;

FIG. 2F illustrates another embodiment of a frame for a photo/video capture tunnel for use with the automated photo and/or video documentation system for supply chain operations, in a warehouse setting;

FIG. 3 illustrates an overhead plan view of a plurality of warehouse shipping lanes using photo/video capture tunnels;

FIG. 4 is a flow chart of a method for providing automated photo and/or video documentation system for supply chain operations; and

FIG. 5 is a block diagram of a system including a computing device for performing the method of FIG. 4.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

In supply chain environments, the documentation of pallets during various stages of handling and transportation may present significant challenges. Traditional manual documentation methods may require warehouse staff to individually photograph each pallet, record identifying information, and manually upload and organize these records. This process may be time-consuming, labor-intensive, and prone to human error. The inconsistency in documentation quality may lead to difficulties in verifying the condition and contents of shipments, potentially resulting in disputes between suppliers, carriers, and customers.

When pallets are prepared for shipment, warehouse personnel may need to capture images from multiple angles to properly document the condition and contents. This may involve walking around each pallet, taking individual photographs, and manually associating these images with the correct shipment information. In a high-volume warehouse environment, this process may significantly slow down operations and create bottlenecks in the shipping workflow. The manual nature of this task may also lead to missed documentation or inconsistent image quality across different personnel.

In cases where documentation is incomplete or of poor quality, resolving disputes about damaged goods or incomplete shipments may become challenging. Without clear visual evidence of the condition of pallets at the time of shipment, companies may face difficulties in determining responsibility for damages or shortages. This may result in financial losses, customer dissatisfaction, and strained business relationships throughout the supply chain.

The integration of documentation processes with existing warehouse management systems may also present challenges. Manual documentation may exist separately from digital inventory and shipping records, making it difficult to associate visual evidence with specific shipments. This disconnection between visual documentation and digital records may hinder efficient retrieval of information when needed for verification or dispute resolution purposes.

During peak shipping periods, the time required for manual documentation may become particularly problematic. Warehouse staff may need to balance the need for thorough documentation with the pressure to process shipments quickly. This balancing act may lead to compromises in documentation quality or completeness, potentially creating issues later in the supply chain when verification is needed.

The storage and organization of manually captured images may present additional challenges. Without a standardized system for naming, tagging, and storing images, retrieving specific documentation when needed may be difficult and time-consuming. This may be particularly problematic when documentation needs to be accessed months after a shipment has occurred, such as in the case of delayed damage claims or quality audits.

Training warehouse personnel on proper documentation procedures may require significant resources. Different individuals may interpret documentation requirements differently, leading to inconsistencies in the captured images. Staff turnover may further complicate this issue, as new employees may need to be continuously trained on documentation protocols.

In multi-location operations, maintaining consistent documentation practices across different facilities may be challenging. Each location may develop its own approach to documentation, making it difficult to establish standardized processes across the organization. This lack of standardization may complicate quality control efforts and make it difficult to compare documentation from different facilities.

The manual handling of cameras or mobile devices in warehouse environments may also present practical challenges. Warehouse personnel may need to set aside other tools or equipment to operate cameras, potentially creating inefficiencies in their workflow. The risk of damage to documentation devices in the industrial environment may also be a concern.

These challenges highlight the need for an automated solution that can streamline the documentation process, ensure consistency in image quality and coverage, integrate seamlessly with existing warehouse management systems, and provide efficient storage and retrieval of visual documentation. Such a solution may help address the inefficiencies and potential disputes that can arise from inadequate documentation in supply chain operations.

The automated photo and/or video documentation system for supply chain operations may provide a solution to the challenges of manual documentation in warehouse environments. The system may include a photo/video capture tunnel structure with strategically positioned cameras that can simultaneously capture images of pallets from multiple angles. This approach may significantly streamline the documentation process and ensure consistent, high-quality visual records.

The system may utilize a frame structure that may be constructed from aluminum for durability while maintaining mobility through attached wheels. The frame may be designed to accommodate pallets positioned within it and may provide mounting points for cameras and other components. The dimensions of the frame structure may be customizable to fit different warehouse layouts and pallet sizes, with a typical size being approximately 10 feet by 10 feet, creating an enclosed area large enough for double-stacked pallets.

A photo and/or video capture initiation device may be included in the system. This device may be embodied as a mobile device such as a smartphone or tablet with a user interface that allows operators to initiate the capture process. The device may be configured to capture metadata associated with pallets by scanning barcodes or QR codes, or through optical character recognition of text on labels. This metadata may include information such as load numbers, delivery numbers, or shipment numbers that can be associated with the captured images.

The system may employ a plurality of cameras mounted on the frame structure. These cameras may be positioned to capture images from different angles, providing comprehensive documentation of the pallets. In some embodiments, at least four cameras may be used: one capturing a first corner of the pallets, another capturing the opposite corner, a third capturing an inside view of a trailer, and a fourth capturing images of labels applied to the pallets. Each camera may be configured to produce an audible sound and activate a flash upon capturing images, providing feedback to operators and ensuring proper illumination.

The captured images and associated metadata may be transmitted to a cloud-based storage system. This storage system may be configured to organize and index the received data, making it easily retrievable when needed. The system may determine if a load record corresponding to the received metadata already exists and either add the new images to that record or create a new record as appropriate. This organization may facilitate efficient retrieval of documentation for verification or dispute resolution purposes.

The system may include a communication interface that facilitates the transmission of data between components. This interface may support wireless protocols such as Wi-Fi or Bluetooth, allowing for flexible deployment in warehouse environments. The communication system may be designed to handle secure transmission of data and may include features such as buffering capability for operation during temporary network outages.

The automated documentation system may be integrated with existing warehouse management systems or enterprise resource planning platforms through appropriate APIs. This integration may allow the visual documentation to complement existing text-based tracking systems, providing a more comprehensive record of supply chain operations.

By automating the documentation process, the system may address the inefficiencies, inconsistencies, and potential for human error associated with manual documentation methods. The solution may help warehouse operations maintain thorough visual records of shipments, which may be valuable for quality control, dispute resolution, and overall supply chain transparency.

The present disclosure includes many aspects and features. Moreover, while many aspects and features relate to, and are described in, the context of an automated photo documentation system for supply chain operations, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

A photo and/or video capture system may include an aluminum frame with mounted cameras. The system may be positioned near dock doors in a warehouse. Pallets may be placed within the frame. The system may capture photos and/or videos of the pallets from multiple angles. It may automatically tag the photos and/or videos with metadata such as load numbers. The photos and/or videos, along with associated metadata, may be uploaded to a cloud platform. This may reduce the time and effort required to document pallet loading compared to manual processes.

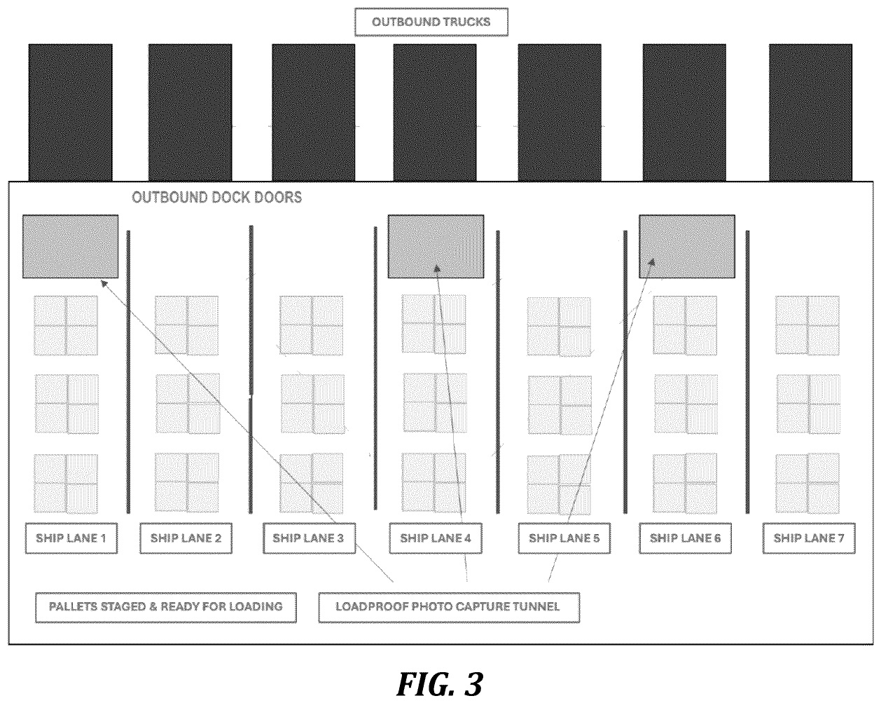

As shown in FIG. 3, the system may include one or more photo/video capture tunnels, each comprising a frame structure. The frame structure may be constructed from aluminum frames. The frame structure may include wheels for mobility. The photo/video capture tunnel may be designed to accommodate pallets positioned within it. The system may incorporate multiple photo/video capture tunnels disposed at different ship lanes within a warehouse.

A plurality of cameras may be mounted on the frame structure. The cameras may be positioned to capture photos and/or videos from different angles of the pallets. There may be at least four cameras in the system. Each camera may be configured to capture at least one photo and/or at least one video of the pallets positioned within the photo/video capture tunnel. In some embodiments, the plurality of cameras may comprise or be embodied as a plurality of tablet cameras (e.g., a plurality of tablet computing devices, where each tablet computing device includes a camera).

The system may include at least one mobile device. The mobile device may be configured to capture metadata associated with pallets positioned within the photo/video capture tunnel. The metadata may include load identification data such as a load number, delivery number, or shipment number. The mobile device may capture the metadata by scanning a barcode associated with the pallets.

The mobile device may be further configured to transmit a signal to initiate photo and/or video capture. The signal to initiate photo and/or video capture may be triggered by a user tapping a screen of the mobile device. Alternatively, the signal may be triggered by activating an external switch connected to the mobile device.

Each of the cameras may be configured to receive the signal to initiate photo and/or video capture. Upon receiving the signal, each camera may capture at least one photo and/or at least one video of the pallets positioned within the photo/video capture tunnel. The cameras may produce an audible sound upon capturing a photo and/or video. The cameras may also activate a flash upon capturing a photo and/or video.

The system may include a cloud-based storage system. The cloud-based storage system may be configured to receive and store photos and/or videos and associated metadata from the plurality of cameras. Each camera may be configured to transmit the captured photos and/or videos and the associated metadata to the cloud-based storage system.

Embodiments of the present disclosure may comprise methods, systems, and a computer readable medium comprising, but not limited to, at least one of the following:
A. A Frame Structure;
B. A Photo and/or Video Capture Initiation Device;
C. A Plurality of Cameras;
D. A Storage System;
E. A Communication Interface; and

In some embodiments, the present disclosure may provide an additional set of modules for further facilitating the software and hardware platform. The additional set of modules may comprise, but not be limited to:
F. A Load/Delivery Tracking System.

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components as found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving, at a photo and/or video initiation device, load identification data for a pallet;
transmitting, from the photo and/or video initiation device to a plurality of camera devices, a signal to initiate photo and/or video capture and the load identification data;
capturing, by each of the plurality of camera devices, at least one image of the pallet, each camera device capturing one or more images from a different angle;
generating, by each of the plurality of camera devices, metadata associated with the captured images, wherein the metadata comprises the load identification data;
uploading, by each of the plurality of camera devices, the captured images and associated metadata to a cloud storage system;
determining, by the cloud storage system, if a load record corresponding to the load identification data exists;
responsive to a determination that the load record corresponding to the load identification data exists, adding the uploaded images and metadata to the existing load record; and
responsive to a determination that the load record corresponding to the load identification data does not exist, creating a new load record corresponding to the load identification data, the new load record comprising the uploaded images and metadata.

Although the aforementioned method has been described to be performed by an automated photo and/or video documentation system 100 for supply chain operations, it should be understood that computing device 500 may be used to perform the various stages of the method. Furthermore, in some embodiments, different operations may be performed by different networked elements in operative communication with computing device 500. For example, a plurality of computing devices may be employed in the performance of some or all of the stages in the aforementioned method. Moreover, a plurality of computing devices may be configured much like a single computing device 500. Similarly, an apparatus may be employed in the performance of some or all stages in the method. The apparatus may also be configured much like computing device 500.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

An automated photo/video documentation system provides a comprehensive solution for documenting pallets during various stages of handling and transportation in supply chain environments. This system addresses the inefficiencies and inconsistencies associated with traditional manual documentation methods.

The system includes a photo/video capture tunnel with a frame structure that may be constructed from aluminum for durability while maintaining mobility through attached wheels. The frame structure may be positioned near dock doors in warehouses and may accommodate pallets placed within it for documentation purposes.

The system may utilize multiple cameras mounted strategically on the frame to capture images from different angles simultaneously. Typically, at least four cameras may be employed: one capturing a first corner of the pallets, another capturing the opposite corner, a third capturing an inside view of a trailer, and a fourth capturing images of labels applied to the pallets. These cameras may be embodied as tablet computers with integrated cameras in some implementations.

A mobile device may serve as the photo/video capture initiation device, allowing warehouse staff to trigger the documentation process. This device may capture metadata associated with the pallets by scanning barcodes or QR codes, or by photographing alphanumeric text data (e.g., an identifying code, and/or a copy of the metadata itself). The metadata may include information such as (but not limited to) load numbers, delivery numbers, or shipment numbers. The mobile device may transmit this metadata along with a signal to initiate photo/video capture to all cameras substantially simultaneously.

Upon receiving the signal, each camera may capture at least one photo and/or video of the pallets from its unique perspective. The cameras may produce audible sounds and/or activate flashes upon capturing images, providing feedback to operators and helping to ensure proper illumination.

The captured images and associated metadata may be transmitted to a cloud-based storage system, which may organize and index the received data for efficient retrieval. The system may determine if a load record corresponding to the metadata already exists and either add the new images to that record or create a new record, as appropriate.

By automating the documentation process, this system may significantly reduce the time and effort required compared to manual methods. It may ensure consistent, high-quality visual records that may be valuable for quality control, dispute resolution, and overall supply chain transparency. The system may also integrate with existing warehouse management systems or enterprise resource planning platforms through appropriate APIs, complementing text-based tracking systems with comprehensive visual documentation.

The system for automated photo and/or video documentation in supply chain operations may be particularly adapted to address the challenges associated with capturing comprehensive documentation of double-stacked pallets. When pallets are stacked vertically, traditional documentation methods may fail to adequately capture all relevant aspects of both the upper and lower pallets, potentially leading to incomplete records and disputes regarding shipment conditions.

The photo/video capture tunnel may be specifically designed with dimensions and camera positioning that accommodate double-stacked pallets. The frame structure may have a height of approximately 10 feet, providing sufficient clearance for capturing images of pallets stacked one on top of another. This vertical clearance may ensure that the entire height of double-stacked pallets may be properly documented without requiring separate documentation processes for each level.

Camera positioning may be a critical aspect of the system's ability to document double-stacked pallets effectively. The plurality of cameras mounted on the frame structure may be strategically positioned at different heights to capture both the upper and lower pallets simultaneously. For example, at least one camera may be mounted at a lower position to capture the base pallet clearly, while another camera may be positioned higher to properly document the top pallet. This multi-height camera arrangement may ensure that all sides of both pallets may be visible in the captured images.

The system may employ angled camera positioning to address the challenge of capturing pallets that may be partially obscured due to stacking. Cameras may be mounted at specific angles calculated to provide optimal visibility of both upper and lower pallets, even when the lower pallet may be partially hidden by the upper one. These angles may be adjustable to accommodate different pallet configurations and stacking arrangements.

Lighting considerations may be particularly important when documenting double-stacked pallets. The system may incorporate additional lighting elements mounted at various heights on the frame structure to ensure proper illumination of both upper and lower pallets. These lighting elements may be positioned to minimize shadows that could otherwise obscure important details of the lower pallet. The lighting system may be configured to activate automatically when the photo/video capture process is initiated, ensuring consistent illumination for all documentation.

The software controlling the camera system may include features specifically designed for double-stacked pallet documentation. The system may be programmed to recognize the presence of double-stacked pallets and may automatically adjust camera settings such as focus, exposure, and field of view to ensure optimal capture of both pallets. This intelligent adjustment may help ensure that neither the upper nor lower pallet receives preferential documentation treatment.

The metadata capture capabilities of the system may be enhanced to include information specific to double-stacked pallets. The mobile device used for initiating photo/video capture may be configured to record whether pallets are single or double-stacked, and may capture individual identification information for both the upper and lower pallets. This detailed metadata may be associated with the captured images, providing context for the visual documentation and enabling proper organization in the storage system.

In some implementations, the system may capture sequential images of the pallets during the stacking process. This may provide documentation of both individual pallets before stacking and the completed double-stack arrangement. Such sequential documentation may be valuable for verifying the condition of each pallet before stacking and may help resolve disputes about damage that may have occurred during the stacking process versus damage that may have occurred during transport.

The cloud-based storage system may organize images of double-stacked pallets in a hierarchical structure that maintains the relationship between upper and lower pallets while allowing individual access to documentation of each pallet. This organization may facilitate efficient retrieval of relevant images when needed for verification or dispute resolution purposes.

By addressing these specific challenges related to double-stacked pallet documentation, the automated photo/video documentation system may provide comprehensive visual evidence of pallet condition and contents regardless of stacking configuration. This complete documentation may reduce disputes, improve accountability, and enhance transparency throughout the supply chain.

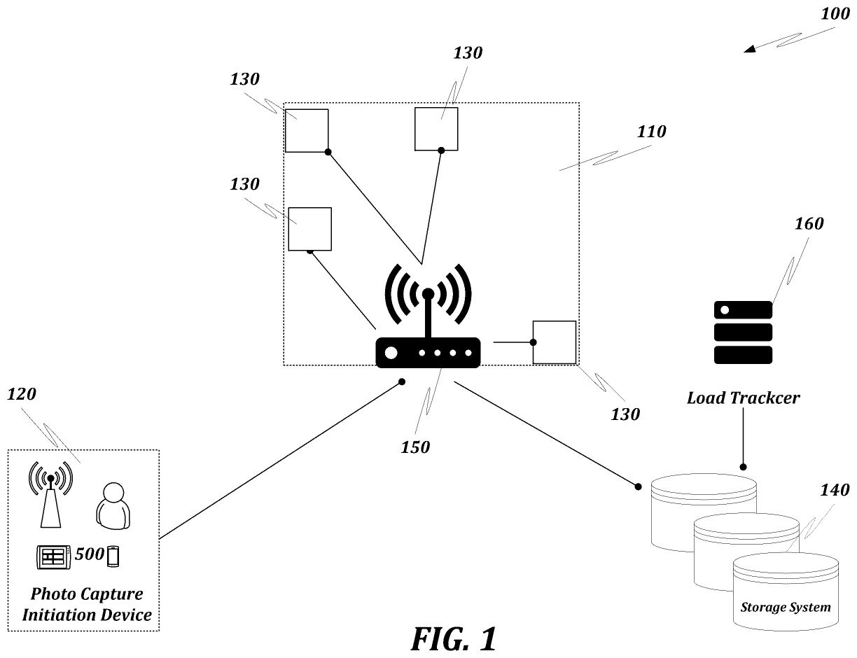

FIG. 1 illustrates one possible operating environment through which a platform consistent with embodiments of the present disclosure may be provided. By way of non-limiting example, an automated photo and/or video documentation system 100 for supply chain operations may be hosted on, for example, a cloud computing service. In some embodiments, the system 100 may be hosted on a computing device 500. A user may access system 100 through a software application and/or hardware device. The software application may be embodied as, for example, but not be limited to, a website, a web application, a desktop application, and a mobile application compatible with the computing device 500.

Accordingly, embodiments of the present disclosure provide a software and hardware platform comprised of a distributed set of computing elements, including, but not limited to:

### A. A Frame Structure

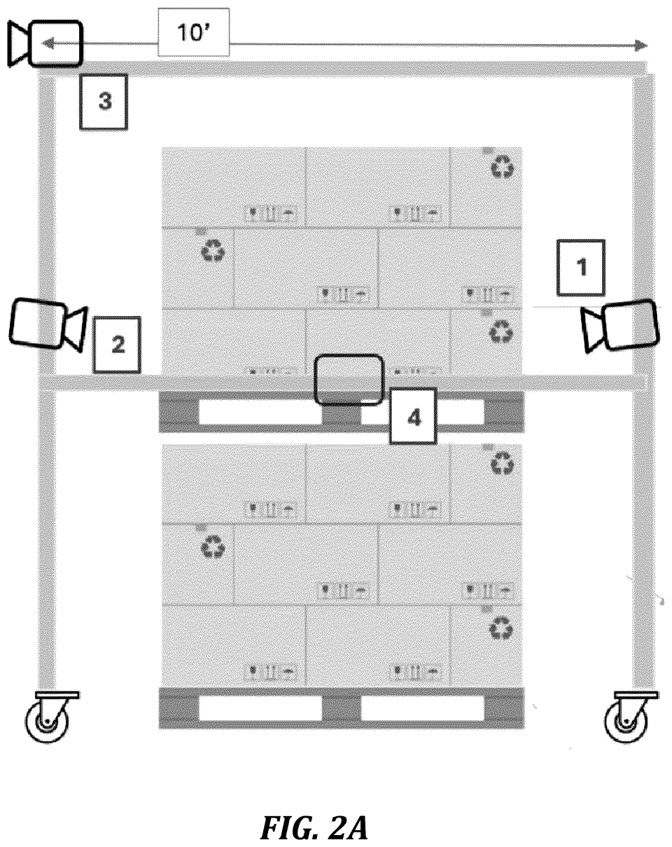

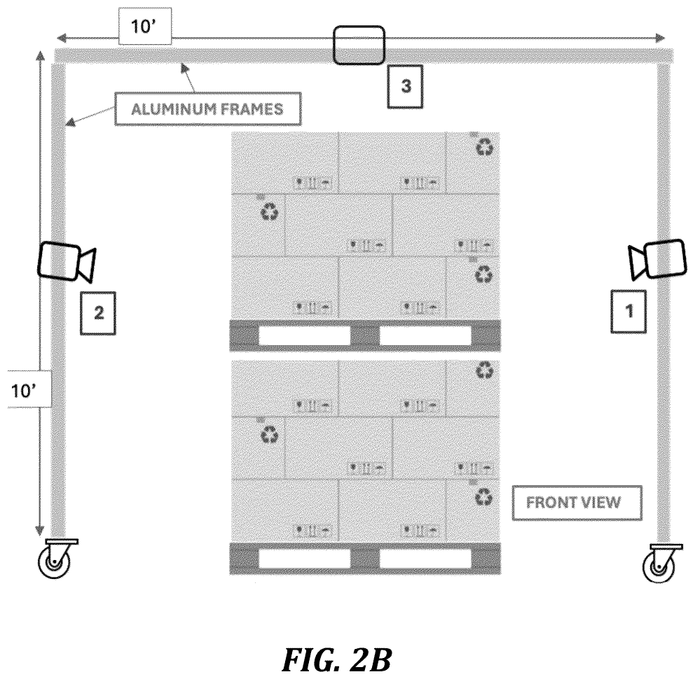

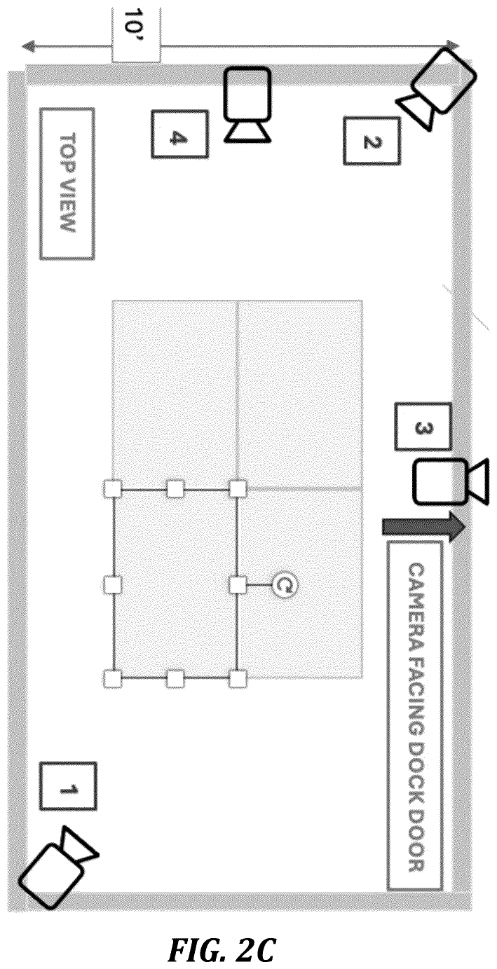

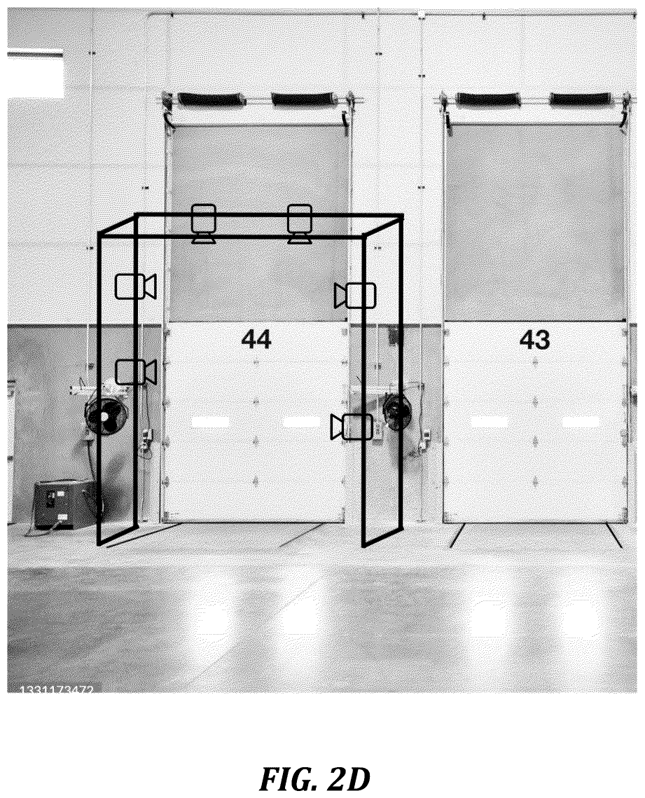

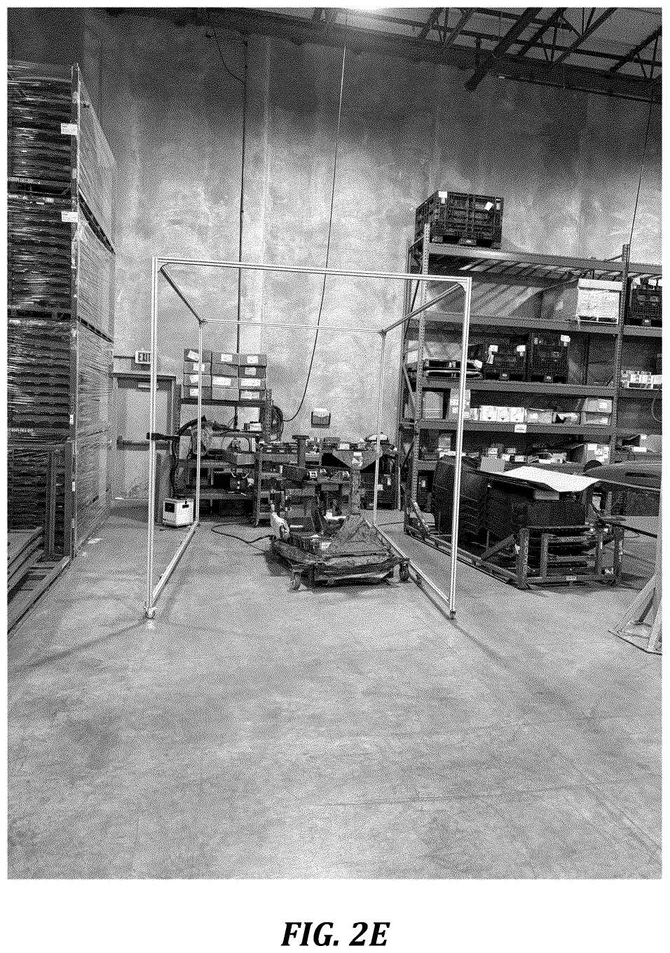

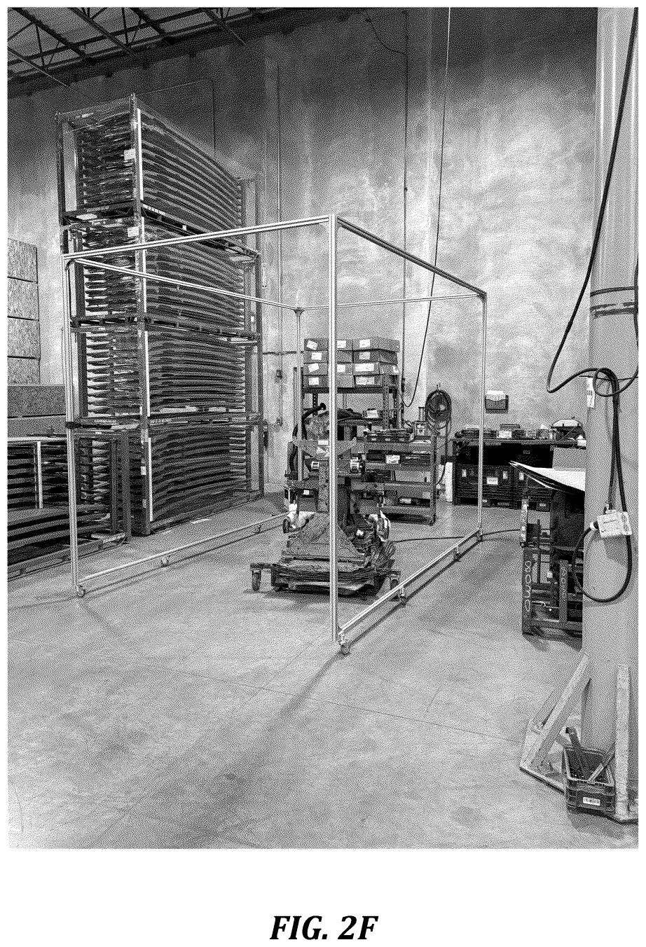

As best shown in FIGS. 2A-2F, the system 100 may include a frame structure 110. The frame structure 110 may comprise a frame and wheels for mobility. The frame may provide a flexible mounting system for the cameras. The frame structure 110 may be designed to allow for adjustable positioning and/or orientation of the cameras to capture optimal angles of the pallets.

The frame may include a plurality of vertical posts connected by horizontal bars. As one non-limiting example, horizontal bars may be disposed at the top and bottom of each vertical post. This configuration may create a rectangular structure suitable for mounting devices. The frame may be supported on wheels to enable easy movement between different dock doors or locations within the warehouse.

The frame may be formed from a material chosen for lightweight and durable properties. For example, the frame may be formed from one or more of aluminum, plastic, steel, and/or the like. This may allow the structure to be sturdy enough to securely hold the tablet cameras while still being portable. The frame may be designed to withstand the warehouse environment and potential impacts from forklifts and/or other warehouse equipment.

The frame structure 110 may include a plurality of adjustable mounting mechanisms for the cameras 130. These mounting mechanisms may be configured to enable the tablets or cameras to be positioned at various angles and orientations to optimize image capture of the pallets. The adjustable mounting mechanisms may include brackets with multiple degrees of freedom, allowing for rotation, tilting, and height adjustment of each camera device.

The mounting mechanisms may be formed as brackets designed to hold objects. One or more (e.g., each) of the mounting mechanisms may allow an object to be securely attached while still permitting adjustments to their positioning and/or orientation. The mounting points may enable the objects to be easily removed for maintenance and/or replacement, if needed or desired. The objects may include, but need not be limited to, the cameras, lights (e.g., to ensure the lighting is adequate for clear photo/video capture, fans for air circulation/cooling, panels to provide a photo/video backdrop and reduce background complexity, and/or any other object that may be useful to the photo/video capture process.

Each mounting bracket may be constructed from durable materials such as aluminum or high-strength plastic, and may be designed to securely hold the tablet or camera while still permitting easy adjustment. The brackets may feature locking knobs or levers that may allow warehouse personnel to loosen the mechanism, adjust the camera position, and then lock it firmly in place once the optimal angle has been achieved.

The mounting mechanisms may include ball-and-socket joints that may provide flexibility in camera positioning. These joints may allow for smooth rotation in multiple directions, enabling cameras to be angled precisely toward specific areas of interest on the pallets. The ball-and-socket design may provide approximately 180 degrees of vertical adjustment and 360 degrees of horizontal rotation, ensuring comprehensive coverage from any desired perspective.

In some embodiments, the mounting mechanisms may incorporate telescoping arms that may extend outward from the frame structure. These arms may allow cameras to be positioned at variable distances from the pallets, accommodating different pallet sizes and capture requirements. The telescoping arms may lock at different extension points to maintain stability during the photo/video capture process.

Swivel mounts may be included in the mounting system to facilitate quick repositioning of cameras between different operational scenarios. These swivel mounts may rotate smoothly on a horizontal plane, allowing cameras to be quickly redirected without the need to adjust multiple components. The swivel functionality may be particularly useful when the system needs to be reconfigured for different types of pallets or documentation requirements.

The mounting mechanisms may include quick-release plates that may enable tablets or cameras to be rapidly removed for maintenance, charging, or replacement. These quick-release mechanisms may feature a secure locking system that prevents accidental detachment during normal operation while still allowing authorized personnel to remove devices when necessary.

Height-adjustable poles may be incorporated into the frame structure to accommodate pallets of varying heights. These poles may extend vertically and lock at different positions, allowing cameras to be raised or lowered to capture optimal images of single pallets, double-stacked pallets, or specialized cargo configurations. The height adjustment mechanism may utilize a pin-lock system or threaded locking collar for secure positioning.

The mounting system may include vibration-dampening elements such as rubber gaskets or spring-loaded components that may reduce the impact of warehouse vibrations on image quality. These elements may be particularly valuable in busy warehouse environments where forklift traffic and other activities may create significant vibrations that could otherwise affect photo/video clarity.

For scenarios requiring specialized lighting, the mounting mechanisms may include attachment points for supplementary lighting equipment. These attachment points may be positioned adjacent to the camera mounts and may be similarly adjustable to ensure proper illumination of the subject matter being documented.

The entire mounting system may be designed for tool-free adjustment, allowing warehouse personnel to reconfigure camera positions quickly without requiring specialized equipment. This feature may enhance the system's flexibility and reduce the time required to adapt to different documentation scenarios.

In some implementations, the mounting mechanisms may include graduated markings or preset positions that may allow for quick, repeatable setup of standard documentation configurations. These reference points may help ensure consistency in documentation across different shifts or operators by providing visual guides for proper camera positioning.

The adjustable mounting mechanisms may be designed to withstand the rigors of warehouse environments, including potential impacts, dust, and temperature variations. The components may be constructed from corrosion-resistant materials and may feature sealed bearings where appropriate to ensure long-term reliability and smooth operation.

The frame structure 110 may be constructed from aluminum or other materials that provide a high strength-to-weight ratio. The aluminum construction may provide sufficient durability to withstand the warehouse environment while remaining lightweight enough for easy mobility. The frame may be formed from extruded aluminum profiles that may be assembled using specialized connectors, allowing for a modular design that may be reconfigured as needed. The aluminum material may also offer resistance to corrosion, which may be beneficial in environments with varying humidity levels or exposure to cleaning chemicals, such as warehouse settings.

The aluminum frame structure 110 may feature a series of vertical posts connected by horizontal crossbars, creating a stable three-dimensional framework. The vertical posts may be positioned at each corner of the structure, with additional support posts optionally placed at strategic intervals to enhance structural integrity. The horizontal crossbars may be attached at multiple heights to create a rigid framework capable of supporting the mounted cameras and other components. The connections between aluminum components may utilize specialized brackets or T-slot fasteners that may allow for secure attachment while permitting adjustments as needed.

The dimensions of the frame structure 110 may be customized based on the specific requirements of the warehouse environment and the size of pallets being documented. A typical configuration may measure approximately 10 feet by 10 feet, creating an enclosed area large enough to accommodate double-stacked pallets. The height of the frame structure 110 may be adjustable, with standard configurations ranging from 8 to 12 feet to accommodate various pallet heights and stacking arrangements. The modular nature of the aluminum framing system may allow for easy modification of these dimensions without requiring complete reconstruction of the frame.

The frame structure 110 may be mounted on wheels, such as heavy-duty caster wheels, to provide mobility throughout the warehouse. These wheels may include locking mechanisms to secure the structure in place during operation. The wheels may be selected based on the floor conditions of the specific warehouse, with options including polyurethane wheels for smooth concrete floors or pneumatic wheels for uneven surfaces. The wheel assembly may be designed to distribute the weight of the frame structure evenly, preventing tipping or instability during movement.

The aluminum frame may incorporate specialized mounting brackets at strategic locations for attaching the cameras 130 and other components. These mounting brackets may be adjustable to allow for precise positioning of the cameras to capture optimal angles of the pallets. The mounting system may include vibration-dampening elements to minimize camera movement during image capture, ensuring clear and consistent documentation. The mounting brackets may be designed for tool-free adjustment, allowing warehouse personnel to reconfigure camera positions without specialized equipment.

The frame structure 110 may include cable management features integrated into the aluminum profiles. These features may include channels or conduits within the aluminum extrusions that may conceal and protect power and data cables running to the cameras and other electronic components. Proper cable management may reduce the risk of damage to cables from forklift traffic or other warehouse activities, while also presenting a cleaner, more professional appearance. The cable management system may also include strain relief mechanisms at connection points to prevent accidental disconnection.

The aluminum frame may be designed with safety features to protect both the equipment and warehouse personnel. These features may include rounded corners and edges to prevent injuries, high-visibility markings or colors to enhance visibility in busy warehouse environments, and protective barriers or padding in areas where accidental contact with forklifts or other equipment may occur. The frame may also include stabilizing elements such as outriggers or weighted bases that may be deployed when the structure is stationary to prevent tipping.

The frame structure 110 may be engineered for quick assembly and disassembly, allowing for efficient relocation between different areas of the warehouse. The aluminum components may be designed with alignment features that ensure proper assembly even by personnel without specialized training. The assembly process may require minimal tools, with many connections utilizing hand-tightened fasteners or quick-release mechanisms. This design approach may reduce downtime when relocating the system and may simplify maintenance procedures.

The aluminum construction may provide natural weatherproofing properties, making the frame suitable for use in various warehouse environments, including those with temperature fluctuations or exposure to moisture. The aluminum material may be anodized or powder-coated to enhance its resistance to environmental factors and to provide additional protection against scratches and wear. These surface treatments may also allow for customization of the frame's appearance to match warehouse branding or safety color schemes.

The frame structure 110 may include provisions for future expansion or modification. The modular nature of the aluminum framing system may allow for the addition of supplementary components such as lighting systems, additional cameras, or environmental sensors. The frame may be designed with standardized mounting interfaces that accommodate a wide range of accessories, ensuring compatibility with future technological upgrades or changing documentation requirements.

The dimensions of the frame structure 110 may be customizable to fit different warehouse layouts and pallet sizes. A typical size may be approximately 10 feet by 10 feet, creating an enclosed area large enough to accommodate double-stacked pallets. In some embodiments, the height of the frame structure 110 may be adjustable to allow for different pallet heights.

While the frame dimensions may be as indicated above, those of skill in the art will recognize that different frame dimensions may be used without departing from the scope of the invention. In some embodiments, as shown in FIG. 2D, the frame 110 may be dimensioned for use in capturing photos and/or videos of pallets that are loaded or unloaded by forklifts, and may be configured to allow the forklift with the pallet to pass through the frame. The configurable nature of the frame 110 makes the system 100 more flexible and lowers cost.

The frame structure 110 may include additional features such as protective barriers or padding to prevent damage to the cameras, the frame itself, and/or pallets held within the frame structure. In some embodiments, the frame structure 110 may also incorporate cable management systems to keep power and data cables organized and out of the way of forklift traffic.

The wheels may be heavy-duty caster wheels capable of supporting the weight of the entire system 100. These wheels may include locking mechanisms to keep the structure stable during use. The wheel design may allow for smooth movement across warehouse floors.

The frame structure 110 may be modular in design, allowing for easy assembly, disassembly, and/or reconfiguration as needed or desired. This modular approach may enable the system 100 to be adapted to different warehouse layouts or shipping processes over time.

B. A Photo and/or Video Capture Initiation Device

The system 100 may include a photo and/or video capture initiation device. The photo and/or video capture initiation device 120 may comprise and/or be embodied as a mobile device configured to trigger a photo and/or video capture process. The mobile device may be, for example, a smartphone, tablet, and/or other handheld computing device. The mobile device may include a user interface that allows a user to initiate photo and/or video capture.

In some embodiments, the user interface of the photo and/or video capture initiation device 120 may include a touchscreen. The touchscreen may display a button or icon that, when tapped or otherwise actuated by a user, transmits a signal to initiate photo and/or video capture.

In some embodiments, the photo and/or video capture initiation device 120 may comprise an external switch connected to the mobile device. The external switch may be a physical button or toggle that, when activated, sends a signal through the mobile device to initiate photo and/or video capture.

The external switch or trigger mechanism may include Bluetooth and/or USB switches similar to those used with SLR cameras. These alternative trigger mechanisms may provide users with the ability to initiate capture without directly touching the tablet screen, which may be particularly valuable in warehouse environments where workers may be wearing gloves or have dirty hands.

The Bluetooth trigger mechanism may be implemented as a small wireless button that can be paired with the mobile device. This Bluetooth trigger may utilize the Bluetooth Low Energy (BLE) protocol to maintain connectivity while minimizing power consumption. The Bluetooth trigger may be configured to transmit a simple signal when pressed, which the mobile device may interpret as a command to initiate the photo/video capture process. The Bluetooth trigger may operate at distances of up to approximately 30 feet from the mobile device, allowing operators flexibility in their positioning during the documentation process.

The USB trigger mechanism may be connected directly to the mobile device through its USB port. This physical connection may provide a more reliable trigger option in environments with significant wireless interference. The USB trigger may be designed with a long cable, typically ranging from 3 to 10 feet, to allow operators some mobility while maintaining the connection. The USB trigger may be recognized by the mobile device as a Human Interface Device (HID), similar to a keyboard or mouse, allowing it to send standardized input commands that can be easily interpreted by the mobile device's operating system.

The system may also support multiple trigger mechanisms connected simultaneously, allowing warehouse teams to implement redundant trigger options for maximum flexibility. For example, a primary operator may use a Bluetooth trigger while a supervisor may have access to the touchscreen interface, allowing either person to initiate the documentation process as needed.

Alternatively or additionally, the photo and/or video capture initiation device 120 may be motion-sensitive. For example, the photo and/or video capture initiation device may be activated by motion of an object (e.g., a forklift, a worker, a pallet, etc.) passing through the associated frame 110 in an automated manner. In this way, the photo and/or video capture initiation device 120 may be configured and set up to capture photos and/or videos of anything in a warehouse or manufacturing plant.

The photo and/or video capture initiation device 120 may be configured to capture metadata associated with the one or more pallets prior to initiating photo and/or video capture. For example, the photo and/or video capture initiation device 120 may include a camera or scanner capable of reading barcodes, QR codes, and/or other machine readable data formats disposed on the pallets and/or associated paperwork. Additionally or alternatively, the photo and/or video capture initiation device 120 may be configured to capture human-readable text (e.g., via an optical character recognition process) to capture metadata associated with one or more pallets. The metadata may include information such as (but not limited to) a load number, delivery number, and/or shipment number. In some embodiments, capture of the metadata (e.g., a successful QR code scan, barcode scan, optical character recognition scan of the metadata, etc.) may cause the photo and/or video capture initiation device 120 to send a signal through the mobile device to initiate photo and/or video capture.

A metadata management module may be implemented to handle the collection, organization, and association of various metadata with captured images. The metadata management module may help to ensure that all relevant information is properly provided to each camera to be linked to each captured image. The metadata management module may include a data collection component. The data collection component may be responsible for gathering metadata from various sources, such as (but not limited to) barcode scans, user input, and/or device information. A data organization component may also be included in the metadata management module. The data organization component may structure the collected metadata in a format suitable for cloud storage and later retrieval.

In some implementations, the photo and/or video capture initiation device 120 may be configured to transmit the captured and structured metadata along with (or as a part of) the signal to initiate photo and/or video capture. This may allow the metadata to be associated with the captured photos and/or videos.

The photo capture and/or video initiation device 120 may include a signal broadcasting component. The signal broadcasting component may be responsible for sending signals (e.g., the signal to initiate photo and/or video capture) from a primary device (e.g., the photo and/or video capture initiation device 120) to a plurality of secondary devices (e.g., the plurality of cameras 130) to initiate simultaneous photo and/or video capture.

The photo and/or video capture initiation device 120 may be portable and movable between different photo and/or video capture tunnel locations. This may provide flexibility in setting up the system 100 at different loading dock doors or staging areas.

The photo and/or video capture initiation device 120 may include wired and/or wireless communication capabilities to transmit signals and data from the photo and/or video capture initiation device to the cameras 130 and/or the storage system. Wireless protocols such as Wi-Fi or Bluetooth may be utilized for communication between the photo and/or video capture initiation device 120 and the cameras 130.

In some embodiments, the photo and/or video capture initiation device 120 may be configured to receive confirmation signals from the cameras 130 after photos and/or videos have been captured and/or after the captured photos and/or videos have been transmitted to the storage device. This may allow the photo and/or video capture initiation device 120 to verify that all cameras 130 successfully captured and/or transmitted photos and/or videos before moving to the next pallet.

The photo and/or video capture initiation device 120 may include a processor and memory for executing software to control the photo and/or video capture process. The software may manage the user interface, metadata capture, signal transmission, and/or other device functions. A user interface module may be provided to create an intuitive and efficient interface for operators using the photo and/or video capture initiation device 120. The user interface module may include components for displaying relevant information and receiving user input. The user interface module may include a touch input component. The touch input component may be responsible for detecting and interpreting user touches on a device screen, such as taps to initiate photo and/or video capture. A display component may also be included in the user interface module. The display component may be responsible for presenting relevant information to the user, such as load details and capture status.

A feedback module may be provided to give users clear indications of system status and successful operations. The feedback module may manage audio and/or visual feedback mechanisms. In some embodiments, the feedback module may include an audio feedback component. The audio feedback component may be responsible for producing audible cues, such as (but not limited to) shutter sounds, to indicate successful photo and/or video capture. Additionally or alternatively, the feedback module may include a visual feedback component. The visual feedback component may manage visual indicators such as (but not limited to) screen flashes or status icons to provide user feedback.

### C. A Plurality of Cameras

The system may include a plurality of cameras 130. In embodiments, one or more (e.g., each) camera 130 may be embodied as a portable computing device (e.g., a tablet computer) including a camera. Each camera 130 may be movably mounted on the frame structure 110 via a mounting point 120. Each camera 130 may be in operative communication with the photo and/or video capture initiation device 125, and may be configured to capture at least one photo and/or video of one or more pallets positioned within the frame 110, responsive to receiving a photo and/or video initiation signal from the photo and/or video capture initiation device. The plurality of cameras 130 may be positioned to capture photos and/or videos of the pallets from different angles.

In some embodiments, the plurality of cameras 130 may comprise at least four cameras: a first camera may be positioned to capture a photograph and/or video of a first corner of the one or more pallets within the frame; a second camera may be positioned to capture a photograph and/or video of a second corner of the one or more pallets, directly opposite the first corner; a third camera may be positioned to capture a photo and/or video of an inside view of a trailer into which the one or more pallets are to be loaded; and fourth camera may be positioned to capture photo and/or video that includes images of labels applied to the one or more pallets. While an embodiment of system 100 including four cameras is shown and described, those of skill in the art will recognize that more or fewer cameras may be used, and that camera placement may be altered, without departing from the scope of the invention.

The camera positioning within the automated photo/video documentation system 100 may include specific angular configurations to help ensure comprehensive documentation of pallets.

Each camera mounting bracket may include adjustable components that allow for fine-tuning of angles (e.g., within ±5 degrees of the recommended positions). This adjustability may accommodate variations in pallet sizes and/or warehouse configurations while maintaining optimal documentation coverage.

The mounting hardware for each camera may include vibration-dampening elements to minimize motion blur in captured images. These elements may consist of rubber gaskets or spring-loaded components that isolate the cameras from the structural vibrations common in warehouse environments.

Camera mounts may be constructed from high-strength aluminum alloy with stainless steel fasteners to ensure durability in warehouse environments. Each mount may feature a quick-release mechanism that allows for rapid camera removal for maintenance or battery replacement while preserving the precise angular positioning upon reinstallation.

For optimal illumination, LED lighting fixtures may be mounted adjacent to each camera position. These lights may be angled to complement the camera positions, eliminating shadows that could obscure important details on the pallets. The lighting system may be synchronized with the camera capture process to ensure consistent illumination across all documentation images.

A calibration procedure may be implemented to maintain optimal camera angles over time. This procedure may involve capturing images of a standardized calibration pallet with known dimensions and reference markers. Software analysis of these calibration images may identify any angular drift and provide adjustment recommendations to restore optimal positioning.

For warehouses handling variable pallet sizes, the camera positioning system may include motorized adjustment capabilities. These motorized mounts may automatically adjust camera angles and distances based on pallet dimensions detected by proximity sensors integrated into the frame structure. This adaptive positioning may ensure optimal documentation regardless of pallet size variations.

The entire camera positioning system may be designed for tool-free adjustment by warehouse personnel. Adjustment points may feature color-coded indicators and graduated markings that correspond to recommended settings for different pallet configurations. This user-friendly design may facilitate rapid reconfiguration when switching between different pallet types or documentation requirements.

In multi-lane warehouse operations, the camera positioning system may be replicated across multiple photo/video capture tunnels. Each tunnel may maintain identical camera configurations to ensure consistency in documentation quality across all shipping lanes. This standardized approach may simplify training requirements and ensure uniform documentation practices throughout the facility.

Each camera 130 may be formed as a tablet computing device including an integrated camera (e.g., a “tablet camera”). In some embodiments, the cameras 130 may be configured to produce an audible sound upon capturing a photo and/or video, such that users and/or employees in the vicinity of the cameras are made aware that an image was captured. In some embodiments, the cameras 130 may be configured to activate a flash in conjunction with capturing a photo and/or video.

Wide-angle camera capabilities may be implemented within the automated photo/video documentation system to enhance the capture of broader views of pallets. These capabilities may help to provide a more comprehensive visual record of pallets during various stages of handling and transportation in supply chain environments.

The system 100 may incorporate wide-angle cameras as one or more of the plurality of cameras 130 mounted on the frame structure 110. These wide-angle cameras may be specifically configured to capture broader field-of-view images that encompass entire pallets or multiple pallets simultaneously. The wide-angle capability may be particularly valuable for capturing double-stacked pallets, where traditional camera angles may not adequately document all relevant aspects in a single frame.

Compatible camera types for wide-angle capture may include smartphones and/or tablet computers with ultra-wide lenses having focal lengths between 13 mm and 18 mm (35 mm equivalent). These smartphones and/or tablet computers may feature sensors with resolutions of at least 12 megapixels to ensure sufficient detail is maintained across the expanded field of view. The wide-angle cameras may be selected based on their ability to maintain image quality at the periphery of the frame, as some wide-angle lenses may introduce significant distortion or softness at the edges.

Mounting considerations for wide-angle cameras may include specialized brackets that allow for precise positioning to maximize coverage while minimizing overlap with standard cameras. These mounting brackets may be designed to secure the smartphones firmly while still permitting adjustments to account for different pallet configurations. The mounting system may include vibration dampening elements to ensure image stability despite warehouse activities that may create vibrations in the frame structure.

Field of view parameters for the wide-angle cameras may be configured to capture approximately 120 to 140 degrees horizontally, compared to the typical 60 to 80 degrees of standard smartphone cameras. This expanded field of view may allow a single wide-angle camera to replace multiple standard cameras in certain configurations, potentially reducing the total number of devices required in the system while maintaining comprehensive documentation coverage.

Image distortion correction may be implemented through software algorithms integrated into the wide-angle camera devices. These algorithms may apply barrel distortion correction to compensate for the characteristic curvature introduced by wide-angle lenses. The distortion correction may be applied in real-time during image capture or as a post-processing step before images are transmitted to the cloud storage system. The correction parameters may be calibrated specifically for each wide-angle camera based on its lens characteristics and mounting position.

The wide-angle images may optionally be processed differently from standard captures to account for their unique characteristics. The processing pipeline may include steps for perspective correction, edge enhancement to maintain detail clarity across the expanded field of view, and dynamic range optimization to handle the varied lighting conditions that may be present across the wider scene. These processing steps may be performed on the smartphone device before transmission to ensure optimal image quality.

Integration of wide-angle imagery with standard captures may be managed through the cloud-based storage system 140. The system may be configured to recognize wide-angle images based on metadata tags and display them appropriately in the user interface. The wide-angle images may be presented alongside standard angle captures in a complementary manner, providing both detailed close-ups and contextual overview images of the same pallets. This integration may enhance the overall documentation value by providing multiple perspectives of the same subject.

Software adjustments to accommodate wide-angle imagery may include modifications to the photo/video capture initiation device 120 to control specific settings for wide-angle cameras. These settings may include exposure compensation to account for the broader scene, focus parameters to ensure proper depth of field across the expanded view, and flash control optimized for wide-angle coverage. The software may also include specialized metadata fields to indicate that an image was captured with a wide-angle lens, which may be valuable for interpretation during dispute resolution or quality control processes.

The wide-angle smartphone cameras may be configured to operate in conjunction with the standard cameras, receiving the same capture signal from the photo/video capture initiation device 120. Upon receiving this signal, the wide-angle cameras may capture their broader view simultaneously with the more focused standard captures, ensuring temporal consistency across all documentation images. This synchronized capture may be particularly valuable for verifying the condition of pallets at a specific moment in time.

The metadata associated with wide-angle captures may include additional fields specific to this camera type, such as lens focal length, field of view angle, and distortion correction parameters applied. This metadata may help users interpret the spatial relationships shown in the images and understand any perspective effects inherent in wide-angle photography. The metadata may also facilitate proper scaling when measurements need to be estimated from the images.

The system may include calibration procedures specifically for wide-angle cameras to ensure accurate documentation. These procedures may involve capturing images of reference objects of known dimensions positioned at various points within the frame. The resulting calibration data may be stored with the camera profile and applied automatically to subsequent captures, helping to maintain consistent and accurate visual documentation despite the inherent distortion of wide-angle lenses.

In some implementations, the cameras 130 may be programmed to capture a sequence of images with slightly different exposure settings to create high dynamic range (HDR) composites. This HDR capability may be especially valuable in warehouse environments with challenging lighting conditions, such as bright loading dock doors adjacent to dimly lit interior spaces. The resulting HDR images may provide more consistent visibility across the entire field of view.

In some embodiments (e.g., where a camera 130 is configured to capture video), the camera may be configured to capture video having a set duration (e.g., 30 seconds). The duration may be long enough to show an operation performed by a worker, to allow an observer to verify the authenticity of the video, etc. In some cases, the duration may be preset based on one or more system settings. In other cases, the duration may be set manually by a user, or automatically (e.g., by the photo and/or video capture initiation device 120).

One or more (e.g., each) of the cameras 130 may be configured to capture images and/or videos in multiple resolutions. As a non-limiting example, the resolution of each image may be selected from low resolution images, medium resolution images, high resolution images, or actual resolution images based on a site-level setting and/or a device-level setting. The system 100 may allow configuring the plurality of cameras 130 to capture different resolution images. In some embodiments, at least one of the cameras 130 may be configured to capture video documentation of the pallet in place of or in addition to capturing a photograph and/or video.

The cameras 130 may generate device information comprising at least one of a tablet name, a tablet model number, an operating system type, a serial number, a manufacturer name, an application name, or an application version. This device information may be uploaded with the captured images and received metadata to the cloud-based storage system.

Each camera 130 may include a listener component to receive signals from the photo and/or video capture initiation device 130 and trigger photo and/or video capture in response. Each camera 130 may be configured to receive a signal to initiate photo and/or video capture (e.g., from the capture initiation device). Upon receiving the signal, each camera 130 may capture at least one photo and/or video of the pallets positioned within the frame 110. The cameras 130 may then transmit the captured photos and/or videos and associated metadata to a storage system.

The system for automated photo and/or video documentation in supply chain operations may be specifically designed to capture detailed label information from pallets and handling units (e.g., using the fourth camera 130, as described above). The image capture capabilities of the system may be optimized to ensure clear, legible documentation of critical identification data present on pallet labels.

One or more (e.g., each) camera 130 within the system 100 may be configured with specific resolution settings to properly capture label details. The cameras may be capable of capturing images at various resolutions, including low resolution, medium resolution, high resolution, or actual resolution, with the appropriate setting selected based on the specific requirements for label documentation at each installation site. For applications where label information is particularly critical, higher resolution settings may be employed to ensure all alphanumeric characters and barcodes are clearly legible.

The system may incorporate advanced focus capabilities to ensure that label text remains sharp and readable even when capturing images from various distances and angles. Auto-focus functionality may be included in each camera to automatically adjust the focal point based on the distance to the label being photographed. This may help ensure that even small text on handling unit labels and pallet identification tags may be captured with sufficient clarity for later verification.

Lighting considerations may be particularly important for proper label documentation. The frame structure 110 may include dedicated lighting elements positioned specifically to illuminate label areas without creating glare or shadows that could obscure important information. These lighting elements may be configured to provide consistent illumination regardless of ambient warehouse lighting conditions, which may vary significantly throughout the day or between different facility locations.

The system may employ specialized image processing techniques to enhance the readability of captured label information. These techniques may include contrast enhancement, sharpening filters, and perspective correction to account for labels that may not be perfectly aligned with the camera. The image processing may be performed either within the camera devices themselves or as part of the cloud storage system's processing pipeline after upload.

For identifying and isolating label regions within the larger image, the system may utilize computer vision algorithms. These algorithms may be designed to automatically detect rectangular label shapes, barcode patterns, or text blocks within the overall image of the pallet. Once detected, these regions may be isolated and potentially subjected to additional processing to further enhance readability.

The fourth camera in the standard configuration may be specifically dedicated to capturing label information. This camera may be positioned at an optimal angle and distance to focus primarily on areas where labels are typically applied to pallets. The mounting mechanism for this camera may allow for precise adjustment to accommodate different label placement across various pallet configurations.

The system may be capable of capturing both human-readable text and machine-readable codes such as barcodes or QR codes from labels. For machine-readable codes, the system may incorporate specialized scanning capabilities that optimize the capture angle and lighting to ensure proper decoding. The resolution requirements for barcode capture may differ from those needed for text capture, and the system may automatically adjust settings accordingly.

In cases where labels may be damaged, partially obscured, or positioned at difficult angles, the system may capture multiple images of the same label area using slightly different settings or angles. This redundancy may help ensure that at least one clear, usable image of each critical label is obtained during the documentation process.

The metadata management module may be configured to extract and associate specific label information with the corresponding images. This may include handling unit identifiers, pallet IDs, load numbers, and other critical tracking information visible on the labels. The extracted data may be structured in a standardized format to facilitate integration with warehouse management systems and enable efficient searching and filtering of records based on label content.

For double-stacked pallets, the system may be specifically designed to capture label information from both the upper and lower pallets. Camera positioning and angles may be optimized to ensure visibility of labels that might otherwise be partially obscured in a stacked configuration. This comprehensive documentation may help maintain complete traceability throughout the supply chain.

The system may include validation capabilities to verify that captured label information meets expected formats or patterns. For example, if a handling unit ID is expected to follow a specific alphanumeric pattern, the system may flag instances where captured label information deviates from this pattern, potentially indicating a documentation error or a mislabeled pallet.

By incorporating these specialized features for label documentation, the automated photo/video documentation system may provide comprehensive, high-quality visual records of pallet and handling unit identification information. This detailed documentation may serve as valuable evidence for verification, dispute resolution, and maintaining transparency throughout the supply chain process.

An image capture module may be provided to manage the actual process of capturing images from multiple angles. The image capture module may control camera settings and ensure consistent image quality across all devices. The image capture module may include a camera control component. This component may be responsible for adjusting camera settings such as resolution, flash, and focus to optimize image quality for different capture scenarios. In some embodiments, a timing component may be included in the image capture module. The timing component may manage the timing of photo and/or video capture across multiple devices to ensure synchronization.

### D. A Storage System

The system 100 may include a storage system 140. In some embodiments, the storage system may be a network-addressable storage system (NAS) and/or a storage area network (SAN). In some embodiments, the storage system 140 may be a cloud-based storage system. The storage system 140 may comprise a server infrastructure configured to receive and store digital images and associated metadata from multiple remote devices (e.g., the plurality of cameras 130). The storage system 140 may include a database for organizing and indexing the received data.

The storage system 140 may implement authentication and encryption protocols to ensure secure transmission and storage of sensitive information. Access controls may be put in place to restrict data visibility based on user permissions.

An application programming interface (API) may be provided to allow integration between the storage system 140 and other enterprise systems, such as (but not limited to) warehouse management software or logistics platforms. The API may enable unidirectional and/or bidirectional data exchange.

The storage system 140 may employ data deduplication and/or compression techniques to optimize storage utilization. Redundancy and/or backup mechanisms may be implemented to protect against data loss.

A user interface may allow authorized personnel to search, view, and/or manage stored images and metadata stored at the storage system 140. The interface may provide filtering and sorting capabilities to quickly locate specific records.

The storage system 140 may generate unique identifiers for each received image set to facilitate organization and retrieval. Metadata fields may be configurable to accommodate different types of supply chain documentation.

Automated processes may be implemented to detect duplicate records based on metadata matching. The system may merge duplicate entries or flag them for manual review.

Version control functionality may track changes made to stored records over time. An audit trail may be maintained to log all access and modifications for compliance purposes.

The storage system 140 may offer scalable infrastructure to accommodate growing data volumes. Load balancing and distributed storage architectures may be utilized to maintain performance.

Automated backup and disaster recovery capabilities may be built into the system. Geographically dispersed data centers may provide redundancy.

Analytics tools may generate reports and insights based on the aggregated image and metadata repository. Machine learning algorithms may be applied to extract useful patterns.

The system may enforce data retention policies, automatically archiving or deleting old records based on configurable rules. Legal hold mechanisms may override standard retention for relevant data.

### E. A Communication Interface

The system may comprise a communication interface 150. The communication interface may be operatively coupled to the at least one of the photo and/or video capture initiation device 130, the plurality of cameras 130 and/or the storage system 140. The communication interface 150 may facilitate or enable transmission of data (e.g., a photo and/or video initiation signal, captured images, metadata, etc.) among the devices operatively coupled thereto. As non-limiting examples, the communication interface may facilitate transmission of the photo and/or video initiation signal and/or metadata from the photo and/or video capture initiation device 130 to the plurality of cameras 130, the transmission of captured photos and/or videos and/or metadata from the plurality of cameras 130 to the storage system 140, and/or an indication of successful photo and/or video capture and upload from the plurality of cameras 130 to the photo and/or video capture initiation device 130.

The communication interface 150 may comprise a wireless network adapter. The wireless network adapter may support Wi-Fi, cellular, Bluetooth, and/or other wireless communication protocols.

In some embodiments, the communication interface 150 may include an Ethernet port and/or other network adapter to allow for wired network connectivity. The network adapter may allow for high-speed data transfer among connected devices.

The communication interface 150 may be configured to establish a secure connection with the remote server. The secure connection may utilize encryption protocols to protect sensitive data during transmission.

In certain implementations, the communication interface 150 may support multiple simultaneous connections. As one example, the multiple simultaneous connections may allow parallel upload of images from different cameras 130 to the storage system 140.

The communication interface 150 may include status indicators. The status indicators may provide visual feedback regarding, among other things, network connectivity and data transmission.

In some configurations, the communication interface 150 may have a dedicated processor. The dedicated processor may handle network operations independently of any other system processor(s).

The communication interface 150 may be capable of buffering data. The buffering capability may allow continued operation during temporary network outages.

In certain embodiments, the communication interface 150 may support quality of service settings. The quality of service settings may prioritize image and metadata uploads over other network traffic.

The communication interface 150 may be field-upgradable. The field-upgradable design may allow for future enhancements to communication capabilities.

In some embodiments, the communication interface 150 may include an upload module to manage the process of uploading captured images and associated metadata to the storage system 140. The upload module may handle data transmission and ensure proper organization of uploaded content. The upload module may include a data packaging component. The data packaging component may be responsible for bundling images with their associated metadata before transmission to the storage system 140. A transmission management component may also be included in the upload module. The transmission management component may handle the actual process of sending data to the storage system 140, including managing network connections and retrying failed uploads.

The transmission management component may be designed to handle the complete process of sending data from the cameras to the cloud storage system, with robust mechanisms to ensure reliable delivery even in challenging warehouse environments. This component may incorporate comprehensive error handling protocols to address transmission failures that could occur due to network issues, server unavailability, or other disruptions.

When a transmission fails, the transmission management component may log the failure details (e.g., including the error type, timestamp, affected file information, and network conditions) at the time of failure. This logging may help in diagnosing recurring issues and improving system reliability over time. The component may classify the error based on its nature (whether the error represents a network connectivity issue, server rejection, authentication failure, data corruption, etc.) and apply an appropriate recovery strategy based at least in part on the error type.

The retry logic within the transmission management component may follow a configurable exponential backoff algorithm. Initial retry attempts may occur within seconds of the failure, with subsequent attempts gradually increasing the waiting period between retries to prevent network congestion. For example, the system may be configured with default parameters of an initial 5-second delay, doubling with each subsequent attempt up to a maximum delay of 2 minutes between retries. The maximum number of retry attempts may be configurable at the site level, with a default setting of 10 attempts before the system flags the transmission for manual intervention. These timing parameters may be adjustable based on specific warehouse network conditions and/or operational requirements.

Bandwidth management techniques may be implemented to optimize uploads, particularly in warehouse environments where network resources may be shared among multiple systems. The transmission management component may include adaptive rate limiting that monitors available network bandwidth and adjusts the upload speed accordingly. During peak warehouse operations, the system may automatically throttle upload speeds to ensure critical warehouse management systems maintain priority access to network resources. The component may also implement batch processing for multiple images, combining metadata and images into efficient transfer packages to reduce overhead and improve throughput.

For handling partial uploads, the transmission management component may implement a chunked transfer mechanism. Large files, such as high-resolution images or videos, may be divided into smaller chunks of configurable size (typically 1 MB). Each chunk may be assigned a unique identifier and sequence number, allowing the system to track exactly which portions of a file have been successfully transmitted. When a partial upload is detected, the system may store the successfully transmitted chunks in temporary storage on the cloud server. Upon reconnection, the transmission management component may query the server to determine which chunks were received and resume the upload by sending only the missing chunks, eliminating the need to restart the entire transmission.

Before transmission, the system may apply various compression methods to reduce file sizes and optimize network usage. For example, image files, may utilize standard compression algorithms such as JPEG with configurable quality settings based on the documentation requirements; video content may undergo H.264 or H.265 encoding with bitrate settings appropriate for documentation purposes. The compression level may be dynamically adjusted based on the current network conditions, applying higher compression during limited bandwidth situations while maintaining sufficient quality for documentation purposes. The system may optionally implement differential compression for sequential images of the same pallet, storing and transmitting only the differences between consecutive frames when appropriate.

Security measures implemented during data transmission may include multiple layers of protection to ensure the integrity and confidentiality of the documentation. For example, all data transmissions may be encrypted using Transport Layer Security (TLS) 1.3 or higher, with certificate-based authentication between the cameras and the cloud storage system. The transmission management component may implement payload signing to verify that the content has not been altered during transmission. Each camera device may be provisioned with unique credentials stored in secure hardware elements where available, preventing unauthorized devices from uploading content to the system. Additionally or alternatively, the system may implement network-level security through configurable IP whitelisting and virtual private network (VPN) tunneling for deployments with heightened security requirements.

The prioritization logic for multiple pending transmissions may ensure that the most critical documentation is uploaded first during periods of limited connectivity or bandwidth. The transmission management component may assign priority levels to different types of documentation based on configurable business rules. For example, documentation of high-value shipments or time-sensitive deliveries may receive higher priority than routine documentation. The system may also prioritize older pending transmissions to prevent indefinite delays of any particular documentation. Within each priority level, the system may implement fair queuing to ensure all cameras have equal opportunity to transmit their documentation. During periods of severely constrained bandwidth, the system may temporarily reduce image resolution and/or increase compression ratios for lower-priority transmissions while maintaining full quality for high-priority documentation.

To confirm successful transmission to cloud storage, the transmission management component may implement a multi-stage verification process. Upon receiving the complete file, the cloud storage system may calculate a cryptographic hash (SHA-256) of the received content and compare it with the hash calculated by the sending device before transmission. This verification ensures that the file was not corrupted during transfer. After successful hash verification, the cloud system may send a digitally signed receipt acknowledgment to the camera device, which the transmission management component stores locally as proof of successful delivery. This receipt includes the file identifier, timestamp, and server confirmation details. The transmission management component may maintain a local database of all transmission attempts, their current status, and receipt confirmations for successful transfers. This database may be periodically synchronized with the cloud system to ensure consistency between local and remote records of successful transmissions. Only after receiving and validating this confirmation may the transmission management component mark the transmission as complete and, if configured to do so, remove the local copy of the transmitted data to free up device storage.

### F. A Load/Delivery Tracking System

In some embodiments, the system 100 may include a load tracking module 160 that may be configured to manage and track load information throughout the photo and/or video capture process. This module 160 may be responsible for associating captured images with specific load identifiers.

The load tracking module 160 may receive load information from the photo and/or video capture initiation device 130, e.g., via a barcode scanning component and/or the plurality of cameras 130. The load tracking module 160 may determine if a load record corresponding to the load identification data already exists in the system. This may involve searching existing records for a matching load number or other identifier. For example, one or more database queries may be used to determine if the load identification data received in the metadata matches or otherwise corresponds to load identification data of any existing load record.

The load tracking module 160 may include a data association component. The data association component may be responsible for linking the load information (e.g., the scanned barcode data) with captured images from the plurality of cameras 130. The data association component may ensure that all images related to a specific load are properly tagged with the correct load identifier.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

Pallet documentation may be captured and managed in a supply chain environment. This process may be performed by a computing device and may include several steps. The method may involve receiving load identification data for a pallet at a first device. The first device may then transmit a signal to initiate photo and/or video capture and the load identification data to multiple camera devices. Each of these camera devices may capture at least one image of the pallet, such that images of the pallet are captured from different angles. The camera devices may generate metadata associated with the captured images, which may include the load identification data. The captured images and associated metadata may be uploaded by each camera device to a storage system. The storage system may determine if a load record corresponding to the load identification data exists. If a load record exists, the uploaded images and metadata may be added to the existing load record. If no load record exists, a new load record corresponding to the load identification data may be created, comprising the uploaded images and metadata.

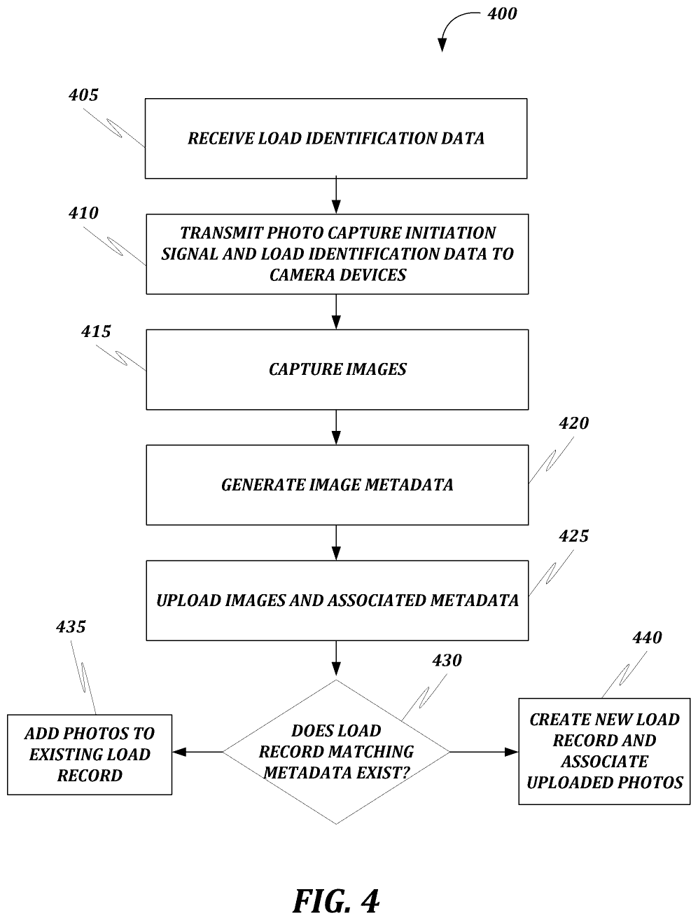

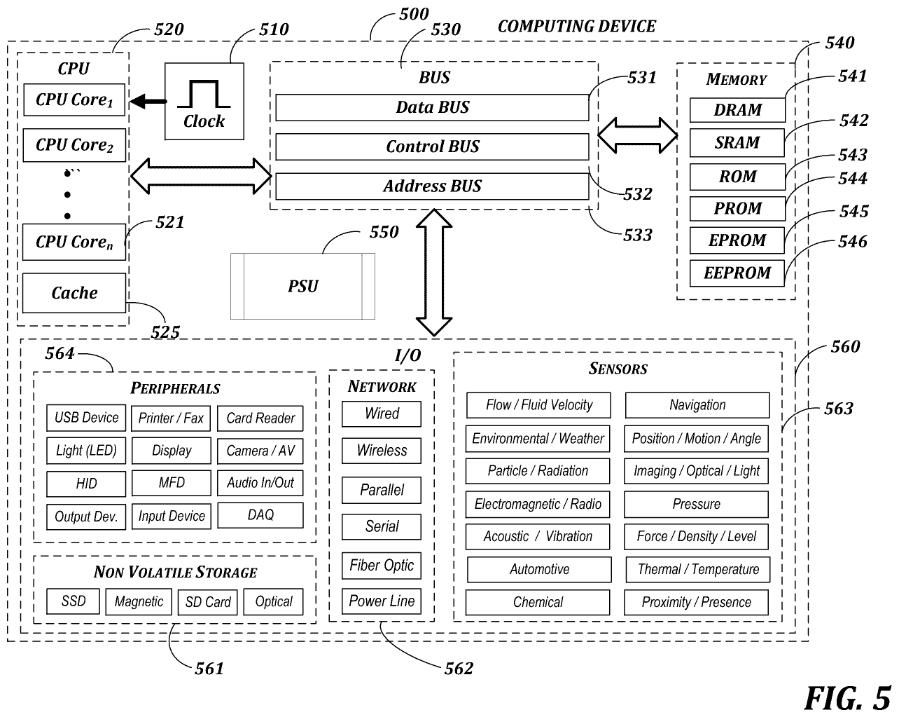

FIG. 4 is a flow chart setting forth the general stages involved in a method 400 consistent with an embodiment of the disclosure for providing automated photo and/or video documentation system 100 for supply chain operations. Method 400 may be implemented using a computing device 500 or any other component associated with system 100 as described in more detail below with respect to FIG. 5. For illustrative purposes alone, computing device 500 is described as one potential actor in the following stages.

The method 400 may begin at stage 405, where the computing device 500 may receive load identification data for a pallet. The load identification data may include a load number, delivery number, or shipment number associated with the pallet. In some embodiments, receiving the load identification data may comprise, for example, receiving user input (e.g., typing) that provides at least a portion of the load identification data. Additionally or alternatively, the computing device 500 may receive at least a portion of the load identification data via an optical input, such as (but not limited to) a barcode scanner, a QR code scanner, or a camera capturing an image of the load identification data.

At stage 410, the computing device 500 may transmit a signal to initiate photo and/or video capture to a plurality of camera devices. The signal may be sent wirelessly (e.g., via Wi-Fi, Bluetooth, and/or various other wireless protocols) to the camera devices. In embodiments, the computing device 500 may transmit the load identification data to the camera devices along with (or as part of) the signal to initiate photo and/or video capture.

At stage 415, each of the plurality of camera devices may capture at least one image of the pallet, such that images of the pallet are captured from multiple different angles. The camera devices may be positioned around the pallet to capture various views. As one non-limiting example, one device may capture a corner shot, another an opposite corner shot, another an inside view of a trailer, and another may capture images of labels on the pallet. More, fewer, and/or different shots may be captured by the plurality of cameras. In some implementations, at least one of the camera devices may capture video documentation in place of or in addition to capturing an image. This provides more comprehensive visual records showing the condition of the pallet at the time the pallet left the warehouse.

The camera devices may be configured to capture images having different resolutions. In one non-limiting example, image resolution options may include low, medium, high or actual resolution, though one of skill in the art will recognize that other resolutions and/or other designations may be used. The image resolution used by each camera device may be selected based on one or more of: site-level settings, device-level settings, and/or user input.

At stage 420, at least one of the camera devices may generate metadata associated with the captured images. The metadata may comprise the load identification data received from the computing device 500. In some embodiments, the metadata may include additional data including (but not limited to) a timestamp, a device identifier, and/or the like. In some embodiments, the metadata may include device information associated with the camera device that captured the image. The device information may include details such as, but not limited to, the tablet name, model number, operating system, serial number, manufacturer, app name, and/or version.

The device information collection process within the automated photo/video documentation system involves several technical mechanisms that ensure comprehensive metadata is captured from each camera device in the system. This information becomes an integral part of the documentation record, providing valuable context about the capture equipment used.

Device information may be automatically generated by each camera device at the time of system initialization. When a camera device is first configured within the photo/video capture tunnel, the device may execute a self-identification routine that collects various hardware and software parameters. This initialization process may involve querying the device's operating system for specific device characteristics through system API calls. The device information may include the tablet name, tablet model number, operating system type, serial number, manufacturer name, application name, and application version.

The technical mechanism for device discovery may utilize the Android Package Manager or similar system services to extract device-specific information. For example, on Android-based tablet cameras, the system may use the Build class to access device manufacturer information (Build.MANUFACTURER), model information (Build.MODEL), and unique device identifiers (Build.SERIAL). The application may also query its own PackageInfo object to determine the application version (PackageInfo.versionName) and application name.

When a photo and/or video capture event is triggered by the photo/video capture initiation device 120, each camera 130 may not only capture the visual content but may also package the previously collected device information with the image data. This packaging process may occur within the data packaging component of the upload module. The device information may be structured as a JSON or XML object containing key-value pairs for each device parameter, creating a standardized format that can be consistently processed by the cloud storage system.

The transmission of device information may occur simultaneously with the image upload process. Each camera 130 may transmit both the captured photo/video content and the associated device information to the cloud-based storage system 140 through the communication interface 150. The transmission may utilize secure HTTP POST requests or similar protocols, with the device information included either in the request headers or as part of a multipart form data payload.

Upon receipt at the cloud-based storage system 140, the device information may be extracted from the incoming data stream and incorporated into the metadata structure associated with the uploaded images. The storage system may maintain a hierarchical data model where each image record contains both the visual content and a metadata object. Within this metadata object, the device information may be stored as a nested structure, allowing for efficient querying and filtering based on specific device parameters.

The device information may be particularly valuable for quality control and troubleshooting purposes. For example, if images from a particular device consistently show quality issues, administrators may use the device information to identify patterns related to specific hardware configurations or software versions. This information may also be useful for audit trails, providing a complete record of which devices were used to capture specific documentation.

The system may also implement a device registration process where new cameras added to the frame structure 110 may be required to register their device information with the cloud storage system 140 before being authorized to upload content. This registration process may involve a secure handshake where the device provides its identification information and receives authentication credentials for future uploads.

For organizations with multiple photo/video capture tunnels deployed across different warehouse locations, the device information may include location identifiers or tunnel association data. This additional contextual information may allow the system to organize and filter documentation based not only on the load identification data but also on the specific capture equipment and location used.

The device information collection and incorporation process may be designed to be non-intrusive to the primary photo/video capture workflow. The collection of device information may occur in the background during system initialization and may be automatically appended to each capture without requiring additional user interaction. This ensures that comprehensive device metadata is consistently included with all documentation while maintaining the streamlined user experience that is central to the system's value proposition.

In some embodiments, one or more (e.g., each) of the camera devices may make an audible upon completing image capture. This provides audio feedback to the user. Additionally or alternatively, the camera devices may activate a visual indicator, such as a flash, in conjunction with image capture. The visual indicator may operate both to notify a user that the image is being captured and to provide consistent illumination for the captured image.

At stage 425, each camera device may upload the captured images and associated metadata to a storage system. The uploads may occur automatically after image capture. The storage system may include a remote server accessible over a network connection. In some embodiments, the storage system may include a cloud-based system. Additionally or alternatively, the storage system may include a Network Addressable Storage device (NAS) and/or a Storage Area Network (SAN). The storage system may incorporate a database or other data retention structure to organize and index received data (e.g., based on the load identification data and/or other received metadata). The storage system may be configured to interface with other enterprise systems like Enterprise Resource Planning (ERP) or Warehouse Management System (WMS) platforms. This allows integration of the image data with other business systems.

At stage 430, the computing device 500 may determine if a load record corresponding to the load identification data already exists in the system. This may involve searching existing records for a matching load number or other identifier. For example, one or more database queries may be used to determine if the load identification data received in the metadata matches or otherwise corresponds to load identification data of any existing load record.

The cloud storage system may implement a structured database architecture for storing and managing load records. This database architecture may include relational tables designed to efficiently organize and retrieve documentation data. The primary table may store load records with unique identifiers corresponding to the load identification data received from the photo/video capture initiation device. Each load record may contain fields for essential metadata such as load numbers, delivery numbers, shipment numbers, timestamps, and status indicators.

The system may utilize a hierarchical data model where each load record serves as a parent entity with child relationships to multiple image records. This structure may allow for efficient organization of images associated with a particular load while maintaining the relationship between different documentation sets captured at various stages of the supply chain process. The image records may contain references to the actual image files stored in a separate file system, along with specific metadata related to each capture such as camera position, resolution settings, and device information.

When determining if a load record exists, the cloud storage system may employ a multi-step matching algorithm. This algorithm may first perform an exact match query against the primary load identifier (typically the load number or delivery number). If no exact match is found, the system may optionally execute a secondary fuzzy matching process that accounts for potential variations in format or partial information. The fuzzy matching process may utilize techniques such as Levenshtein distance calculations or phonetic matching algorithms to identify potential matches despite minor differences in the load identification data.

The query methods utilized by the cloud storage system may include indexed database searches optimized for performance. The system may maintain separate indices for each type of load identifier (load number, delivery number, shipment number) to facilitate rapid lookups regardless of which identifier is provided. These indices may be implemented using B-tree or hash table structures depending on the specific performance requirements and data characteristics. For high-volume operations, the system may implement query caching mechanisms that temporarily store the results of recent lookups to reduce database load and improve response times.

The cloud storage system may handle edge cases through a series of specialized processes. For partial matches where some but not all identification data corresponds to existing records, the system may present potential matches to users through the mobile interface, allowing for manual confirmation before proceeding. This approach may help prevent the creation of duplicate records while still accommodating situations where complete identification data may not be available.

For corrupted identification data, the system may implement data validation routines that check for expected formats and character sets before processing. When corruption is detected, the system may attempt to recover usable portions of the identification data and match against those fragments. If recovery is not possible, the system may generate a temporary identifier and flag the record for manual review and potential merging with the correct record once complete information becomes available.

The database structure may also include transaction logging capabilities that record all attempts to match load identification data, including successful matches, failed matches, and edge cases. These logs may be valuable for troubleshooting and auditing purposes, providing a complete history of how the system processed each piece of identification data received from the field.

In cases where multiple potential matches are found, the system may employ a weighted scoring algorithm that considers factors such as recency of the existing record, completeness of the match, and confidence levels in the matching process. Records exceeding a configurable threshold score may be considered matches, while those falling below may trigger the creation of new records or manual review processes depending on system configuration.

The cloud storage system may also implement conflict resolution mechanisms for situations where multiple devices attempt to create or modify load records with similar identification data simultaneously. These mechanisms may utilize timestamp-based locking or optimistic concurrency control to ensure data integrity while minimizing disruption to the documentation workflow.

At stage 430, the computing device 500 may determine if a load record corresponding to the load identification data already exists in the system. This determination may involve a database query that searches for records with matching load numbers, delivery numbers, or other identifying information contained in the metadata. The query may be structured to handle variations in format or partial information, allowing for robust matching even when the identification data may not be completely standardized.

If the system determines that a matching load record exists, it may proceed to stage 435, where the newly uploaded images and metadata are added to the existing record. This process may involve updating database relationships to associate the new images with the existing load identifier while preserving the original documentation. The system may maintain chronological ordering of images within each load record, allowing users to track the documentation history over time.

If no matching load record is found at stage 430, the system may proceed to stage 440, where it creates a new load record using the identification data provided in the metadata. The new record may be structured according to the database schema, with appropriate relationships established between the load identifier and the uploaded images. The system may also generate additional metadata at this stage, such as creation timestamps and system-generated unique identifiers to facilitate future reference.

The determination process may include safeguards against creating duplicate records due to minor variations in identification data. These safeguards may include normalization of input data (removing spaces, standardizing case, etc.) before comparison and secondary verification checks that consider multiple identification fields simultaneously rather than relying on a single field match.

For high-volume operations, the load record determination process may utilize database optimization techniques such as prepared statements, connection pooling, and query caching to maintain performance even under significant load. The system may also implement asynchronous processing for certain aspects of the determination and record creation workflow, allowing the user-facing components to remain responsive while database operations are completed in the background.

The cloud storage system may maintain audit trails of all record determinations, creations, and modifications, providing a complete history of how each piece of documentation was processed and organized. These audit trails may be valuable for troubleshooting, compliance purposes, and resolving potential disputes about when and how documentation was captured and stored.

In some implementations, the system may provide configurable thresholds for what constitutes a matching record, allowing organizations to adjust the sensitivity of the matching algorithm based on their specific documentation requirements and tolerance for potential duplication. These configuration options may be managed through administrative interfaces that provide authorized users with control over the system's behavior without requiring direct database manipulation.

The load record determination process may also incorporate machine learning components that improve matching accuracy over time by analyzing patterns in how identification data is formatted and entered across different warehouse locations or by different operators. These learning components may adapt to organization-specific conventions and gradually reduce the need for manual intervention in edge cases.

The automated photo/video documentation system may incorporate a sophisticated machine learning (ML) system for matching pallets across different documentation events. This ML system may enable the identification of the same pallet across multiple capture sessions, facilitating comprehensive tracking throughout the supply chain process.

As one non-limiting example, the pallet matching system may utilize convolutional neural networks (CNNs) and/or similarity learning approaches. The core algorithm may be based on a Siamese neural network architecture, which may be particularly effective for image matching tasks.

The ML system may be trained using a triplet loss function, which may encourage the network to produce similar embeddings for images of the same pallet and dissimilar embeddings for different pallets. The training dataset may require careful preparation to ensure effective learning. The dataset may need to include multiple images of the same pallets captured at different angles, images of the same pallets at different points in time, images of different pallets with similar characteristics, images captured under varying lighting conditions and environmental factors, and/or the like.

The dataset preparation process may involve manual annotation of pallet identities across thousands of images. Data augmentation techniques may be applied to expand the training set, including random rotations, brightness adjustments, contrast modifications, and partial occlusions to simulate real-world variability.

The feature extraction process for pallet images may involve multiple specialized techniques, including (but not necessarily limited to): edge detection and contour analysis implemented using Sobel operators to identify the structural boundaries of pallets; texture analysis using Local Binary Pattern (LBP) features, which may capture surface characteristics of the pallet and its contents; color histogram analysis to capture the distribution of colors on the pallet, which may be particularly useful for identifying specific products or packaging; deep feature extraction (e.g., using pre-trained CNN models and fine-tuned for the specific task of pallet recognition) to capture high-level semantic information about the pallet contents. The final feature vector may be a concatenation of these different feature types, potentially followed by dimensionality reduction techniques such as Principal Component Analysis (PCA) to improve computational efficiency.

By implementing this comprehensive machine learning system for pallet matching, the automated photo/video documentation system may provide robust tracking capabilities throughout the supply chain, enhancing visibility, accountability, and dispute resolution capabilities.

At stage 435, If the received load identification data corresponds to an existing load record, the computing device 500 may add the uploaded images and metadata to the existing load record. This allows multiple image sets to be associated with a single load.

Alternatively, at stage 440, if no matching load record is found, the cloud system may create a new load record corresponding to the load identification data. The new record may include the uploaded images and metadata.

### IV. Computer Architecture

Embodiments of the present disclosure provide a hardware and software platform operative as a distributed system of modules and computing elements.

System 100 may include or be embodied as, for example, but not be limited to, a website, a web application, a desktop application, a backend application, and a mobile application compatible with a computing device 500. The computing device 500 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System 1, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
System 100 may be hosted on a centralized server or a cloud computing service. Although method 400 has been described to be performed by a computing device 500, it should be understood that, in some embodiments, different operations may be performed by a plurality of the computing devices 500 in operative communication on at least one network.

Embodiments of the present disclosure may comprise a system having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for redundancy, high availability, and/or performance purposes. The combination of the presently disclosed units is configured to perform the stages of any method disclosed herein.

FIG. 5 is a block diagram of a system including computing device 500. Consistent with an embodiment of the disclosure, the aforementioned CPU 520, the bus 530, the memory unit 540, a PSU 550, and the plurality of I/O units 560 may be implemented in a computing device, such as computing device 500 of FIG. 5. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, and the memory unit 540, consistent with embodiments of the disclosure.

At least one computing device 500 may be embodied as any of the computing elements illustrated in all of the attached figures. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In some configurations, the computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

In a system consistent with an embodiment of the disclosure, the computing device 500 may include the clock module 510, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 520, the central component of modern computers, which relies on a clock signal. The clock 510 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 500 may use a “clock multiplier” which multiplies a lower frequency external clock to the appropriate clock rate of the CPU 520. This allows the CPU 520 to operate at a much higher frequency than the rest of the computing device 500, which affords performance gains in situations where the CPU 520 does not need to wait on an external factor (like memory 540 or input/output 560). Some embodiments of the clock 510 may include dynamic frequency change, where, the time between clock edges can vary widely from one edge to the next and back again.

In a system consistent with an embodiment of the disclosure, the computing device 500 may include the CPU 520 comprising at least one CPU Core 521. In other embodiments, the CPU 520 may include a plurality of identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU 520 reads and executes program instructions which may be used across many application domains, for example, but not limited to, general purpose computing, embedded computing, network computing, digital signal processing (DSP), and graphics processing (GPU). The CPU 520 may run multiple instructions on separate CPU cores 521 simultaneously. The CPU 520 may be integrated into at least one of a single integrated circuit die, and multiple dies in a single chip package. The single integrated circuit die and/or the multiple dies in a single chip package may contain a plurality of other elements of the computing device 500, for example, but not limited to, the clock 510, the bus 530, the memory 540, and I/O 560.

The CPU 520 may contain cache 522 such as but not limited to a level 1 cache, a level 2 cache, a level 3 cache, or combinations thereof. The cache 522 may or may not be shared amongst a plurality of CPU cores 521. The cache 522 sharing may comprise at least one of message passing and inter-core communication methods used for the at least one CPU Core 521 to communicate with the cache 522. The inter-core communication methods may comprise, but not be limited to, bus, ring, two-dimensional mesh, and crossbar. The aforementioned CPU 520 may employ symmetric multiprocessing (SMP) design.

The one or more CPU cores 521 may comprise soft microprocessor cores on a single field programmable gate array (FPGA), such as semiconductor intellectual property cores (IP Core). The architectures of the one or more CPU cores 521 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the computing device 500, and/or the plurality of computing devices 500. The aforementioned communication system will be known to a person having ordinary skill in the art as a bus 530. The bus 530 may embody internal and/or external hardware and software components, for example, but not limited to a wire, an optical fiber, various communication protocols, and/or any physical arrangement that provides the same logical function as a parallel electrical bus. The bus 530 may comprise at least one of a parallel bus, wherein the parallel bus carries data words in parallel on multiple wires; and a serial bus, wherein the serial bus carries data in bit-wise serial form. The bus 530 may embody a plurality of topologies, for example, but not limited to, a multidrop/electrical parallel topology, a daisy chain topology, and connected by switched hubs, such as a USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCIe) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to persons having ordinary skill in the art as primary storage or memory 540. The memory 540 operates at high speed, distinguishing it from the non-volatile storage sub-module 561, which may be referred to as secondary or tertiary storage, which provides relatively slower-access to information but offers higher storage capacity. The data contained in memory 540, may be transferred to secondary storage via techniques such as, but not limited to, virtual memory and swap. The memory 540 may be associated with addressable semiconductor memory, such as integrated circuits consisting of silicon-based transistors, that may be used as primary storage or for other purposes in the computing device 500. The memory 540 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 500 may employ a communication system between an information processing system, such as the computing device 500, and the outside world, for example, but not limited to, human, environment, and another computing device 500. The aforementioned communication system may be known to a person having ordinary skill in the art as an Input/Output (I/O) module 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces with a plurality of hardware, such as, but not limited to, non-volatile storage 561, communication devices 562, sensors 563, and peripherals 564. The plurality of hardware is used by at least one of, but not limited to, humans, the environment, and another computing device 500 to communicate with the present computing device 500. The I/O module 560 may comprise a plurality of forms, for example, but not limited to channel I/O, port mapped I/O, asynchronous I/O, and Direct Memory Access (DMA).

Consistent with the embodiments of the present disclosure, the aforementioned computing device 500 may employ a non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 540. The non-volatile storage sub-module 561 may not lose data when power is removed and may be orders of magnitude less costly than storage used in memory 540. Further, the non-volatile storage sub-module 561 may have a slower speed and higher latency than in other areas of the computing device 500. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 500 may employ a communication sub-module 562 as a subset of the I/O module 560, which may be referred to by a person having ordinary skill in the art as at least one of, but not limited to, a computer network, a data network, and a network. The network may allow computing devices 500 to exchange data using connections, which may also be known to a person having ordinary skill in the art as data links, which may include data links between network nodes. The nodes may comprise networked computer devices 500 that may be configured to originate, route, and/or terminate data. The nodes may be identified by network addresses and may include a plurality of hosts consistent with the embodiments of a computing device 500. Examples of computing devices that may include a communication sub-module 562 include, but are not limited to, personal computers, phones, servers, drones, and networking devices such as, but not limited to, hubs, switches, routers, modems, and firewalls.

Two nodes can be considered networked together when one computing device 500 can exchange information with the other computing device 500, regardless of any direct connection between the two computing devices 500. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 562 may comprise a plurality of size, topology, traffic control mechanisms and organizational intent policies. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 500 may employ a sensors sub-module 563 as a subset of the I/O 560. The sensors sub-module 563 comprises at least one of the device, module, or subsystem whose purpose is to detect events or changes in its environment and send the information to the computing device 500. Sensors may be sensitive to the property they are configured to measure, may not be sensitive to any property not measured but be encountered in its application, and may not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge,
Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ a peripherals sub-module 564 as a subset of the I/O 560. The peripheral sub-module 564 comprises ancillary devices uses to put information into and get information out of the computing device 500. There are 3 categories of devices comprising the peripheral sub-module 564, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 564:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 500 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 562), data storage devices (non-volatile storage 561), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Aspects

The following discloses various Aspects of the present disclosure. The various Aspects are not to be construed as patent claims unless the language of the Aspect appears as a patent claim. The Aspects describe various non-limiting embodiments of the present disclosure.

The automated photo and/or video documentation system for supply chain operations may include additional innovative features to enhance its functionality and adaptability in warehouse environments. The system may incorporate machine learning capabilities to automatically identify and flag damaged pallets or inconsistencies in packaging. This intelligent detection feature may provide early warning of potential issues before they progress through the supply chain.

The frame structure may include adjustable height mechanisms to accommodate various pallet configurations beyond the standard dimensions. These mechanisms may include telescoping posts or modular extension components that can be added or removed as needed. The frame may also feature quick-release mounting brackets that allow for rapid reconfiguration of camera positions without tools, enabling warehouse staff to optimize documentation angles for different types of shipments.

Each camera in the system may be equipped with depth-sensing technology to capture not only visual documentation but also dimensional data of the pallets. This three-dimensional documentation may provide more comprehensive evidence of load configuration and may assist in verifying proper loading techniques and weight distribution. The depth data may be converted into 3D models that can be rotated and examined from any angle within the cloud storage system.

The photo and/or video capture initiation device may include voice recognition capabilities, allowing warehouse staff to trigger documentation hands-free while handling paperwork or operating equipment. The system may respond to specific voice commands that include load identification information, eliminating the need for manual data entry in some cases.

Environmental sensors may be integrated into the frame structure to document ambient conditions at the time of capture. These sensors may record temperature, humidity, and light levels, which may be critical for temperature-sensitive shipments or products with specific environmental requirements. This environmental metadata may be stored alongside the visual documentation and load identification data.

The storage system may implement blockchain technology to create an immutable record of documentation. Each photo or video capture event may be recorded as a transaction in the blockchain, providing an audit trail that cannot be altered. This feature may be particularly valuable for high-value shipments where chain of custody and verification of condition are essential.

For facilities with multiple photo/video capture tunnels, the system may include a central management dashboard that provides real-time status updates of all tunnels. The dashboard may display metrics such as documentation volume, system utilization, and queue status. It may also facilitate load balancing by directing warehouse staff to the least busy tunnel during peak periods.

The system may support scheduled documentation sessions for regular shipments. Warehouse managers may program the system to automatically prepare for documentation of specific loads at predetermined times, based on shipping schedules. This feature may streamline operations for recurring shipments and reduce the need for manual setup.

Integration capabilities may extend beyond traditional warehouse management systems to include transportation management systems and customer relationship management platforms. This broader integration may enable end-to-end visibility of shipment documentation throughout the entire supply chain, from manufacturer to end customer.

These enhanced features may further differentiate the automated photo/video documentation system from traditional manual documentation methods, providing greater efficiency, accuracy, and value to supply chain operations.

1. A system for automated photo and/or video capture of pallets in a supply chain environment, comprising:
a content capture tunnel comprising a frame structure;
a plurality of cameras mounted on the frame structure;
at least one mobile device configured to:
capture metadata associated with one or more pallets positioned within the content capture tunnel, and
transmit a signal to initiate content capture; and
a cloud-based storage system configured to receive and store content and associated metadata from the plurality of cameras;
wherein each of the plurality of cameras is configured to:
receive the signal to initiate content capture,
capture content comprising at least one photo or video of the one or more pallets positioned within the content capture tunnel, and
transmit the captured content and the associated metadata to the cloud-based storage system.

2. The system of claim 1, wherein the frame structure comprises aluminum framing and wheels for mobility.

3. The system of claim 1, wherein the plurality of cameras comprise at least four cameras positioned to capture photos and/or videos of the pallets from different angles.

4. The system of claim 1, wherein the at least one mobile device is further configured to capture the metadata by scanning a barcode associated with the one or more pallets.

5. The system of claim 1, wherein the signal to initiate content capture is triggered by one or more of the following:
a user tapping a screen of the at least one mobile device; or
a user activating an external switch connected to the at least one mobile device.

6. The system of claim 1, wherein each of the plurality of cameras is further configured to:
produce an audible sound upon capturing content, and
activate a flash upon capturing content.

7. The system of claim 1, wherein the cloud-based storage system is further configured to:
determine if a load associated with the received metadata already exists in the system, and
responsive to determining that the load associated with the received metadata exists, add the received content and metadata to the existing load.

8. A system for automated documentation of pallets in a supply chain environment, comprising:
a documentation station comprising a frame structure;
a plurality of imaging devices mounted on the frame structure;
a control device configured to:
obtain load identification data associated with pallets positioned within the documentation station, and
transmit a capture signal to the plurality of imaging devices; and
a data storage system;
wherein each of the plurality of imaging devices is configured to:
receive the capture signal from the control device,
in response to receiving the capture signal, capture at least one image of the pallets positioned within the documentation station, and
transmit the at least one image and the load identification data to the data storage system.

9. The system of claim 8, wherein the plurality of imaging devices comprise tablet computers with integrated cameras.

10. The system of claim 8, wherein the control device comprises a mobile device with a user interface for initiating the capture signal.

11. The system of claim 8, wherein the data storage system comprises a cloud-based storage system configured to associate the at least one image with the load identification data.

12. The system of claim 8, wherein the load identification data comprises at least one of a load number, a delivery number, and a shipment number.

13. The system of claim 8, wherein the plurality of imaging devices are positioned to capture images of multiple sides of the pallets simultaneously.

14. The system of claim 8, wherein the data storage system is further configured to:
determine if a load record corresponding to the load identification data exists; and
responsive to determining that no load record corresponding to the load identification data exists, create a new load record based on the load identification data.

15. The system of claim 8, wherein each of the plurality of imaging devices is configured to generate device information comprising at least one of a device name, a model number, an operating system type, a serial number, a manufacturer name, an application name, or an application version, and wherein the device information is included in the load identification data.

16. The system of claim 8, wherein the documentation station further comprises one or more lighting components mounted on the frame structure to provide consistent illumination for image capture.

17. The system of claim 8, wherein at least one of the plurality of imaging devices is configured to capture video documentation of the pallets.

18. A method for capturing and managing pallet documentation in a supply chain environment, comprising:
receiving load identification data for a pallet;
transmitting a signal to initiate photo and/or video capture and the load identification data to a plurality of camera devices;
capturing, by each of the plurality of camera devices, at least one image of the pallet from different angles;
generating metadata associated with the captured images, wherein the metadata comprises the load identification data;
uploading the captured images and associated metadata to a storage system;
determining if a load record corresponding to the load identification data exists in the storage system;
responsive to a determination that the load record corresponding to the load identification data exists, adding the uploaded images and metadata to the existing load record; and
responsive to a determination that the load record corresponding to the load identification data does not exist, creating a new load record corresponding to the load identification data, the new load record comprising the uploaded images and metadata.

19. The method of claim 18, wherein the plurality of camera devices comprise:
a first camera device positioned to capture a corner shot of the pallet;
a second camera device positioned to capture an opposite corner shot of the pallet;
a third camera device positioned to capture an inside view of a trailer; and
a fourth camera device positioned to capture images of labels applied to the pallet.

20. The method of claim 18, further comprising:
generating device information comprising at least one of a device name, a device model number, an operating system type, a serial number, a manufacturer name, an application name, or an application version; and
uploading the device information with the captured images and metadata to the storage system.
